(19) United States
(12) Patent Application Publication
(10) Pub. No.: US 2026/0222601 A1
(43) Pub. Date: Jul. 30, 2026

(54) ENCODING AND DECODING METHODS, BIT STREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(73) Assignee: GUANGDONG OPPO MOBILE TELECOMMUNICATIONS CORP., LTD., Dongguan (CN)

(21) Appl. No.: 19/432,090

(22) Filed: Dec. 23, 2025

Related U.S. Application Data
(63) Continuation of application No. PCT/CN2023/106163, filed on Jul. 6, 2023.

(51) Int. Cl. H04N 19/196; H04N 19/105; H04N 19/159; H04N 19/176; H04N 19/33; H04N 19/597; H04N 19/70

(52) U.S. Cl. CPC H04N 19/196; H04N 19/105; H04N 19/159; H04N 19/176; H04N 19/33; H04N 19/70; H04N 19/597

(57) ABSTRACT

The present application discloses encoding and decoding methods, a bit stream, an encoder, a decoder, and a storage medium. The method comprises: by means of first syntax element identification information, indicating whether a unit to be encoded/decoded uses a spatial relationship-based inter-frame nearest neighbor search algorithm for attribute prediction; if yes; further determining a block size corresponding to a current LOD layer in the unit to be decoded; on the basis of the block size corresponding to the current LOD layer, determining a reference block, corresponding to a current point, in a reference frame and a neighboring block having spatial correlation with the reference block; performing inter-frame nearest neighbor search to determine N neighbor points of the current point; and on the basis of the N neighbor points, performing attribute prediction on the current point to determine an attribute reconstruction value.

### CROSS-REFERENCE TO RELATED APPLICATIONS

This application is a continuation of International Application No. PCT/CN2023/106163, filed on Jul. 6, 2023, the disclosure of which is hereby incorporated by reference in its entirety.

### TECHNICAL FIELD

Embodiments of this application relate to the field of point cloud encoding and decoding technologies, and in particular, to an encoding method, a decoding method, a bitstream, an encoder, a decoder, and a storage medium.

### BACKGROUND

In an encoding and decoding framework of geometry-based point cloud compression (Geometry-based Point Cloud Compression, G-PCC) or an encoding and decoding framework of video-based point cloud compression (Video-based Point Cloud Compression, V-PCC) provided by the moving picture experts group (Moving Picture Experts Group, MPEG), geometric information and attribute information of a point cloud are encoded separately.

Currently, a G-PCC attribute prediction module uses a nearest neighbor attribute predictive coding scheme based on a level of detail (Level of Detail, LOD) structure. For performing attribute nearest neighbor search based on LOD division, currently, there are two types of algorithms: intra-frame nearest neighbor search and inter-frame nearest neighbor search. Intra-frame nearest neighbor search includes two algorithms: inter-layer nearest neighbor search and intra-layer nearest neighbor search. Existing inter-frame nearest neighbor search is block-based inter-frame fast search that does not use a spatial distribution characteristic of a point cloud, thereby causing relatively low inter coding efficiency of a point cloud attribute.

### SUMMARY

Embodiments of this application provide an encoding method, a decoding method, a bitstream, an encoder, a decoder, and a storage medium, which can improve attribute encoding efficiency of a point cloud, thereby further improving encoding and decoding performance of the point cloud.

The technical solutions in embodiments of this application may be implemented as follows.

According to a first aspect, an embodiment of this application provides a decoding method, applied to a decoder, where the method includes:
decoding a bitstream to determine first syntax element identification information;
in a case that the first syntax element identification information indicates that a spatial-relationship-based inter-frame nearest neighbor search algorithm is used to perform attribute prediction on a to-be-decoded unit, determining a block size corresponding to a current LOD layer in the to-be-decoded unit;
determining, based on geometric position information of a current point in the current LOD layer and the block size corresponding to the current LOD layer, a reference block that corresponds to the current point and that is in a reference frame and a neighboring block that has spatial correlation with the reference block;
performing inter-frame nearest neighbor search according to the reference block and the neighboring block, to determine N neighboring points of the current point; and
performing attribute prediction on the current point according to the N neighboring points, to determine a reconstructed attribute value of the current point.

According to a second aspect, an embodiment of this application provides an encoding method, applied to an encoder, where the method includes:
determining a block size corresponding to a current LOD layer in a to-be-encoded unit;
determining, based on geometric position information of a current point in the current LOD layer and the block size corresponding to the current LOD layer, a reference block that corresponds to the current point and that is in a reference frame and a neighboring block that has spatial correlation with the reference block;
performing inter-frame nearest neighbor search according to the reference block and the neighboring block, to determine N neighboring points of the current point;
performing attribute prediction on the current point according to the N neighboring points, to determine a reconstructed attribute value of the current point;
calculating, according to an original attribute value and the reconstructed attribute value of a point in the to-be-encoded unit, a cost of using a spatial-relationship-based inter-frame nearest neighbor search algorithm to perform attribute prediction, to determine whether to use the spatial-relationship-based inter-frame nearest neighbor search algorithm to perform attribute prediction on the to-be-encoded unit;
determining first syntax element identification information based on whether to use the spatial-relationship-based inter-frame nearest neighbor search algorithm to perform attribute prediction on the to-be-encoded unit; and
encoding the first syntax element identification information and writing an encoded bit into a bitstream.

According to a third aspect, an embodiment of this application provides a bitstream, where the bitstream is generated by performing bit encoding according to to-be-encoded information, where the to-be-encoded information includes at least one of the following: first syntax element identification information, second syntax element identification information, or third syntax element identification information,
where the first syntax identifier information is used to indicate whether to use a spatial-relationship-based inter-frame nearest neighbor search algorithm to perform attribute prediction on a to-be-decoded unit, the second syntax element identification information is used to indicate a block size corresponding to a current LOD layer, and the third syntax element identification information is used to indicate whether to use the inter-frame nearest neighbor search algorithm to perform attribute prediction on the to-be-decoded unit.

According to a fourth aspect, an embodiment of this application provides an encoder, where the encoder includes a first determining unit, a second determining unit, and an encoding unit, where
the first determining unit is configured to: determine a block size corresponding to a current LOD layer in a to-be-encoded unit; determine, based on geometric position information of a current point in the current LOD layer and the block size corresponding to the current LOD layer, a reference block that corresponds to the current point and that is in a reference frame and a neighboring block that has spatial correlation with the reference block; perform inter-frame nearest neighbor search according to the reference block and the neighboring block, to determine N neighboring points of the current point; and perform attribute prediction on the current point according to the N neighboring points, to determine a reconstructed attribute value of the current point;
the second determining unit is configured to: calculate, according to an original attribute value and the reconstructed attribute value of a point in the to-be-encoded unit, a cost of using a spatial-relationship-based inter-frame nearest neighbor search algorithm to perform attribute prediction, to determine whether to use the spatial-relationship-based inter-frame nearest neighbor search algorithm to perform attribute prediction on the to-be-encoded unit;
the first determining unit is further configured to determine first syntax element identification information based on whether to use the spatial-relationship-based inter-frame nearest neighbor search algorithm to perform attribute prediction on the to-be-encoded unit; and the encoding unit is configured to encode the first syntax element identification information and write an encoded bit into a bitstream.

According to a fifth aspect, an embodiment of this application provides an encoder, where the encoder includes a first memory and a first processor, where
the first memory is configured to store a computer program runnable on the first processor; and
the first processor is configured to execute the method according to the second aspect when running the computer program.

According to a sixth aspect, an embodiment of this application provides a decoder, where the decoder includes a decoding unit and a third determining unit, where
the decoding unit is configured to decode a bitstream to determine first syntax element identification information;
the third determining unit is configured to: in a case that the first syntax element identification information indicates that a spatial-relationship-based inter-frame nearest neighbor search algorithm is used to perform attribute prediction on a to-be-decoded unit, determine a block size corresponding to a current LOD layer in the to-be-decoded unit; and
the third determining unit is further configured to: determine, based on geometric position information of a current point in the current LOD layer and the block size corresponding to the current LOD layer, a reference block that corresponds to the current point and that is in a reference frame and a neighboring block that has spatial correlation with the reference block; perform inter-frame nearest neighbor search according to the reference block and the neighboring block, to determine N neighboring points of the current point; and perform attribute prediction on the current point according to the N neighboring points, to determine a reconstructed attribute value of the current point.

According to a seventh aspect, an embodiment of this application provides a decoder, where the decoder includes a second memory and a second processor, where
the second memory is configured to store a computer program runnable on the second processor; and
the second processor is configured to execute the method according to the first aspect when running the computer program.

According to an eighth aspect, an embodiment of this application provides a computer-readable storage medium, where the computer-readable storage medium stores a computer program, and when the computer program is executed, the method according to the first aspect or the method according to the second aspect is implemented.

Embodiments of this application provide an encoding method, a decoding method, a bitstream, an encoder, a decoder, and a storage medium. First syntax element identification information is used to indicate whether to use a spatial-relationship-based inter-frame nearest neighbor search algorithm to perform attribute prediction on a to-be-decoded unit. If the first syntax element identification information indicates that the spatial-relationship-based inter-frame nearest neighbor search algorithm is used to perform attribute prediction on the to-be-decoded unit, a block size corresponding to a current LOD layer in the to-be-decoded unit is further determined. Based on geometric position information of a current point in the current LOD layer and the block size corresponding to the current LOD layer, a reference block that corresponds to the current point and that is in a reference frame and a neighboring block that has spatial correlation with the reference block are determined. Inter-frame nearest neighbor search is performed according to the reference block and the neighboring block, to determine N neighboring points of the current point. Attribute prediction is performed on the current point according to the N neighboring points, to determine a reconstructed attribute value of the current point.

### BRIEF DESCRIPTION OF DRAWINGS

FIG. 1A is a schematic diagram of a three-dimensional point cloud image.

FIG. 1B is a diagram of a locally enlarged view of the three-dimensional point cloud image.

FIG. 2A is a schematic diagram of a point cloud image viewed from six angles.

FIG. 2B is a schematic diagram of a data storage format corresponding to a point cloud image.

FIG. 3 is a schematic diagram of a network architecture of point cloud encoding and decoding.

FIG. 4A is a schematic diagram of a framework of a G-PCC encoder.

FIG. 4B is a schematic diagram of a framework of a G-PCC decoder.

FIG. 5A is a schematic diagram of low planar positions in a Z-axis direction.

FIG. 5B is a schematic diagram of high planar positions in a Z-axis direction.

FIG. 6 is a schematic diagram of a node coding sequence.

FIG. 7A is a schematic diagram of a piece of planar mode information.

FIG. 7B is a schematic diagram of another piece of planar mode information.

FIG. 8 is a schematic diagram of sibling nodes of a current node.

FIG. 9 is a schematic diagram of intersection between lasers of a LiDAR device and a node.

FIG. 10 is a schematic diagram of a neighboring node at a same division depth and a same coordinate.

FIG. 11 is a schematic diagram showing that a current node is located on a low plane of a parent node.

FIG. 12 is a schematic diagram showing that a current node is located on a high plane of a parent node.

FIG. 13 is a schematic diagram of predictive encoding of planar position information of a LiDAR point cloud.

FIG. 14 is a schematic diagram of IDCM coding.

FIG. 15 is a schematic diagram of coordinate transform of a point cloud acquired by a rotating LiDAR device.

FIG. 16 is a schematic diagram of predictive encoding in an X-axis or Y-axis direction.

FIG. 17A is a schematic diagram of an angle for predicting a Y plane by using a horizontal azimuth.

FIG. 17B is a schematic diagram of an angle for predicting an X plane by using a horizontal azimuth.

FIG. 18 is another schematic diagram of predictive encoding in an X-axis or Y-axis direction.

FIG. 19A is a schematic diagram of three vertices included in a block.

FIG. 19B is a schematic diagram of a triangle soup fitted by using three vertices.

FIG. 19C is a schematic diagram of up-sampling performed on a triangle soup.

FIG. 20 is a schematic diagram of a distance-based LOD construction process.

FIG. 21 is a schematic diagram of a visualized result of an LOD generation process.

FIG. 22 is a schematic flowchart of attribute predictive coding.

FIG. 23 is a schematic diagram of composition of a pyramid structure.

FIG. 24 is a schematic diagram of composition of another pyramid structure.

FIG. 25 is a schematic diagram of an LOD structure for inter-layer nearest neighbor search.

FIG. 26 is a schematic structural diagram of performing nearest neighbor search based on a spatial relationship.

FIG. 27A is a schematic diagram of a coplanar spatial relationship.

FIG. 27B is a schematic diagram of coplanar and co-edge spatial relationships.

FIG. 27C is a schematic diagram of coplanar, co-edge, and co-vertex spatial relationships.

FIG. 28 is a schematic diagram of inter-layer prediction based on fast search.

FIG. 29 is a schematic diagram of an LOD structure for inter-layer attribute nearest neighbor search.

FIG. 30 is a schematic diagram of intra-layer prediction based on fast search.

FIG. 31A is a schematic diagram of attribute inter prediction based on fast search.

FIG. 31B is a schematic structural diagram of block-based neighbor search.

FIG. 32 is a schematic flowchart of lifting transform coding.

FIG. 33 is a schematic structural diagram of RAHT.

FIG. 34 is a schematic diagram of a process of RAHT in three directions x, y, and z.

FIG. 35A is a schematic diagram of a forward RAHT process.

FIG. 35B is a schematic diagram of an inverse RAHT process.

FIG. 36 is a schematic flowchart of a decoding method according to an embodiment of this application.

FIG. 37 is a schematic spatial relationship diagram of inter-frame nearest neighbor search based on a spatial relationship.

FIG. 38 is a schematic flowchart of an encoding method according to an embodiment of this application.

FIG. 39 is a schematic structural diagram of an encoder according to an embodiment of this application.

FIG. 40 is a schematic diagram of a specific hardware structure of an encoder according to an embodiment of this application.

FIG. 41 is a schematic structural diagram of a decoder according to an embodiment of this application.

FIG. 42 is a schematic diagram of a specific hardware structure of a decoder according to an embodiment of this application.

FIG. 43 is a schematic structural diagram of a codec system according to an embodiment of this application.

### DESCRIPTION OF EMBODIMENTS

To understand features and technical content of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following descriptions, the term “some embodiments” describes a subset of all possible embodiments, but it may be understood that “some embodiments” may be the same subset or different subsets of all possible embodiments and may be combined without a conflict.

It should also be noted that the term “first/second/third” used in embodiments of this application is merely used to distinguish between similar objects and does not represent a specific order of objects. It may be understood that “first/second/third” may be interchanged if allowed, so that embodiments of this application described herein may be implemented in a sequence other than the sequence illustrated or described herein.

A point cloud is a three-dimensional representation of a surface of an object. By using a collection device such as an optoelectronic radar, a LiDAR device, a laser scanner, or a multi-angle camera, a point cloud (data) of a surface of an object may be collected.

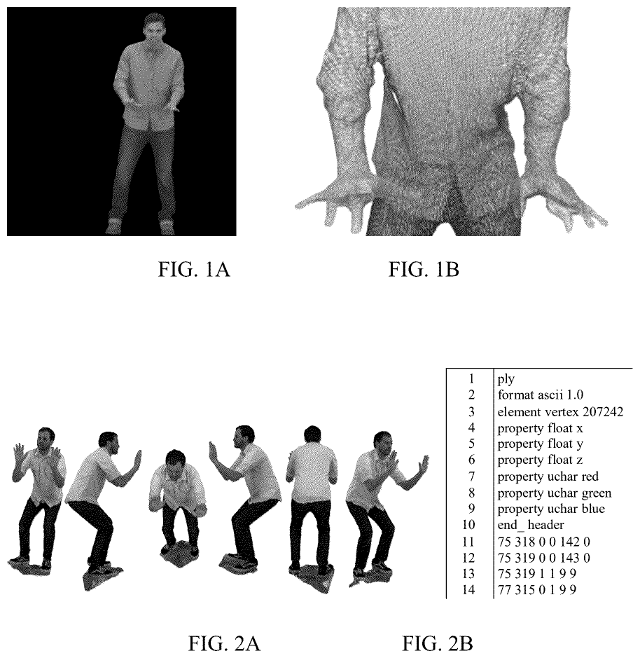

The point cloud is a set of discrete points in space that are irregularly distributed and represent a spatial structure and surface attributes of a three-dimensional object or scene. FIG. 1A is a three-dimensional point cloud image, and FIG. 1B is a locally enlarged view of the three-dimensional point cloud image. It can be seen that a surface of the point cloud includes densely distributed points.

Samples of a two-dimensional image each express some information and follow a distribution rule. Therefore, position information of the two-dimensional image does not need to be additionally recorded. However, points in a point cloud in a three-dimensional space are randomly and irregularly distributed. Therefore, a position of each point in the space needs to be recorded, to fully express the point cloud. Similar to that in the two-dimensional image, in a collection process, each position has corresponding attribute information, which is usually an RGB color value. The color value reflects a color of an object. For the point cloud, in addition to color information, attribute information corresponding to each point generally includes a reflectance value. The reflectance value reflects a surface material of the object. Therefore, data of the point cloud generally includes position information and attribute information of a point. The position information of the point may also be referred to as geometric information of the point. For example, the geometric information of the point may be three-dimensional coordinate information (x, y, z) of the point. The attribute information of the point may include color information and/or reflectance, and the like. For example, the reflectance may be one-dimensional reflectance information (r). The color information may be any type of information in color space, or the color information may be three-dimensional color information, for example, RGB information. Herein, R represents red (Red, R), G represents green (Green, G), and B represents blue (Blue, B). For another example, the color information may be luma and chroma (YCbCr, YUV) information, where Y represents luma (Luma), Cb(U) represents a blue color difference, and Cr(V) represents a red color difference.

A point in a point cloud obtained according to a laser measurement principle may have three-dimensional coordinate information of the point and a reflectance value of the point. For another example, a point in a point cloud obtained according to a photographing measurement principle may have three-dimensional coordinate information of the point and three-dimensional color information of the point. For another example, a point in a point cloud obtained according to a laser measurement principle and a photographing measurement principle may have three-dimensional coordinate information of the point, a reflectance value of the point, and three-dimensional color information of the point.

FIG. 2A and FIG. 2B show a point cloud image and a data storage format corresponding to the point cloud image. FIG. 2A provides six angles of viewing a point cloud image, and FIG. 2B includes a file header information part and a data part. Header information includes a data format, a data representation type, a total quantity of points in a point cloud, and content represented by the point cloud. For example, the point cloud is in a “.ply” format and is represented by an ASCII code. The total quantity of the points in the point cloud is 207242, and each point has three-dimensional coordinate information (x, y, z) and three-dimensional color information (r, g, b).

According to acquisition methods, point clouds may be classified into the following three types:
static point cloud, for which an object is static, and a device for acquiring the point cloud is also static;
dynamic point cloud, for which an object is moving, but a device for acquiring the point cloud is static; and
dynamically acquired point cloud, for which a device for acquiring the point cloud is moving.

For example, according to usage, point clouds are classified into the following two types:
type 1: machine perception point cloud, which may be used in scenarios such as an autonomous navigation system, a real-time inspection system, a geographic information system, a visual sorting robot, and a disaster relief robot; and
type 2: human eye point cloud, which may be used in point cloud application scenarios such as a digital cultural heritage, free viewpoint broadcasting, three-dimensional immersive communication, and three-dimensional immersive interaction.

A point cloud may flexibly and conveniently express a spatial structure and a surface attribute of a three-dimensional object or scene. Since the point cloud is obtained by directly performing sampling on a real object, an extremely strong sense of reality can be provided on a premise of ensuring precision. Therefore, the point cloud is widely applied in virtual reality gaming, computer-aided design, a geographic information system, an automatic navigation system, a digital cultural legacy, free viewpoint broadcasting, three-dimensional immersive remote presentation, three-dimensional reconstruction of a biological organ, and the like.

Point clouds are mainly collected in the following manners: computer generation, 3D laser scanning, 3D photographing measurement, and the like. A computer may be used to generate a point cloud of a virtual three-dimensional object or scene. 3D laser scanning may be used to obtain a point cloud of a three-dimensional object or scene in a static real world, and can acquire millions of point clouds per second. 3D photographing measurement may be used to obtain a point cloud of a three-dimensional object or scene in a dynamic real world, and can acquire tens of millions of point clouds per second. These technologies reduce costs and a time period of acquiring point cloud data, and improve data precision. The development in the manners of acquiring point cloud data makes it possible to acquire a large amount of point cloud data. With increasing application requirements, processing of massive 3D point cloud data encounters bottlenecks of limited storage space and transmission bandwidth.

Exemplarily, a point cloud video with a frame rate of 30 frames per second (fps) is used as an example. A quantity of points in each frame of point cloud is 700,000, and each point has coordinate information xyz (float) and color information RGB (uchar). In this case, a data volume of a 10-second point cloud video is approximately 0.7 million×(4 byte×3+1 byte×3)×30 fps×10s=3.15 GB, where 1 byte is 10 bits. A data volume of a 10-second 1280×720 two-dimensional video with a YUV sampling format of 4:2:0 and a frame rate of 24 fps is approximately ×24 fps×10s≈0.33 GB, and a data volume of a 10-second two-view three-dimensional video is approximately 0.33×2=0.66 GB. It can be seen that a data volume of a point cloud video is far more than a data volume of a two-dimensional or three-dimensional video with a same length. Therefore, to better implement data management, save server storage space, and reduce transmission traffic and transmission time between servers and clients, point cloud compression becomes a key for promoting development of point cloud industries.

That is, since a point cloud is a set of massive points, storing the point cloud not only consumes a large amount of memory but also is non-conducive to transmission. In addition, there is no such bandwidth that can support direct transmission of a point cloud in a network layer without compression. Therefore, the point cloud needs to be compressed.

Currently, a point cloud encoding framework that can be used to compress a point cloud may be a geometry-based point cloud compression (Geometry-based Point Cloud Compression, G-PCC) encoding and decoding framework or a video-based point cloud compression (Video-based Point Cloud Compression, V-PCC) encoding and decoding framework provided by the moving picture experts group (Moving Picture Experts Group, MPEG), or may be an AVS-PCC encoding and decoding framework provided by an AVS. The G-PCC encoding and decoding framework may be used to compress a static point cloud of the type 1 and a dynamically acquired point cloud of the type 3, and may be based on a point cloud compression test platform (Test Model Compression 13, TMC13). The V-PCC encoding and decoding framework may be used to compress a dynamic point cloud of the type 2, and may be based on a point cloud compression test platform (Test Model Compression 2, TMC2). Therefore, the G-PCC encoding and decoding framework is also referred to as a point cloud codec TMC13, and the V-PCC encoding and decoding framework is also referred to as a point cloud codec TMC2.

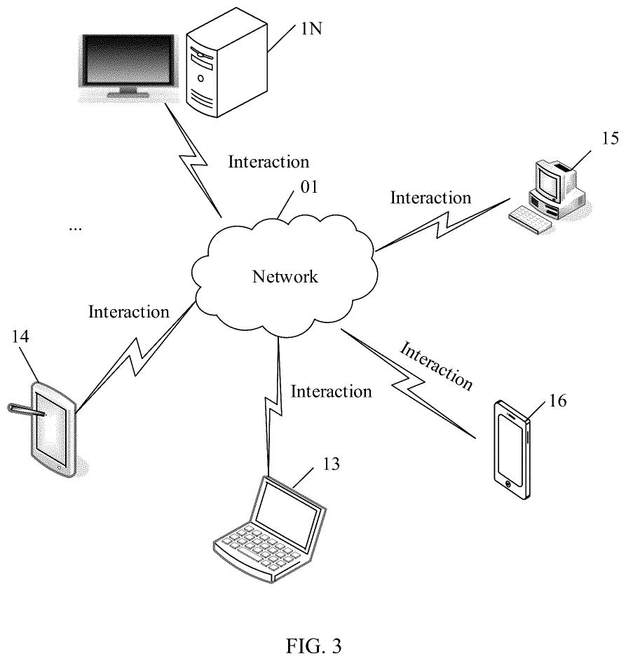

Embodiments of this application provide a network architecture of a point cloud encoding and decoding system including a decoding method and an encoding method. FIG. 3 is a schematic diagram of a network architecture for point cloud encoding and decoding according to an embodiment of this application. As shown in FIG. 3, the network architecture includes one or more electronic devices 13 to 1N and a communications network 01, where the electronic devices 13 to 1N may perform video interaction with each other by using the communications network 01. In an implementation process, the electronic device may be various types of devices that have a point cloud encoding and decoding function. For example, the electronic device may include a mobile phone, a tablet computer, a personal computer, a personal digital assistant, a navigator, a digital telephone, a video telephone, a television, a sensing device, a server, or the like. This is not limited in embodiments of this application. A decoder or an encoder in embodiments of this application may be the foregoing electronic device.

The electronic device in embodiments of this application has a point cloud encoding and decoding function, and generally includes a point cloud encoder (that is, an encoder) or a point cloud decoder (that is, a decoder).

The following describes a related technology by using a G-PCC encoding and decoding framework as an example.

It may be understood that, in a G-PCC encoding and decoding framework for a point cloud, to-be-encoded point cloud data is first partitioned into a plurality of slices through slicing (slice). In each slice, geometric information of the point cloud and attribute information corresponding to each point are separately encoded.

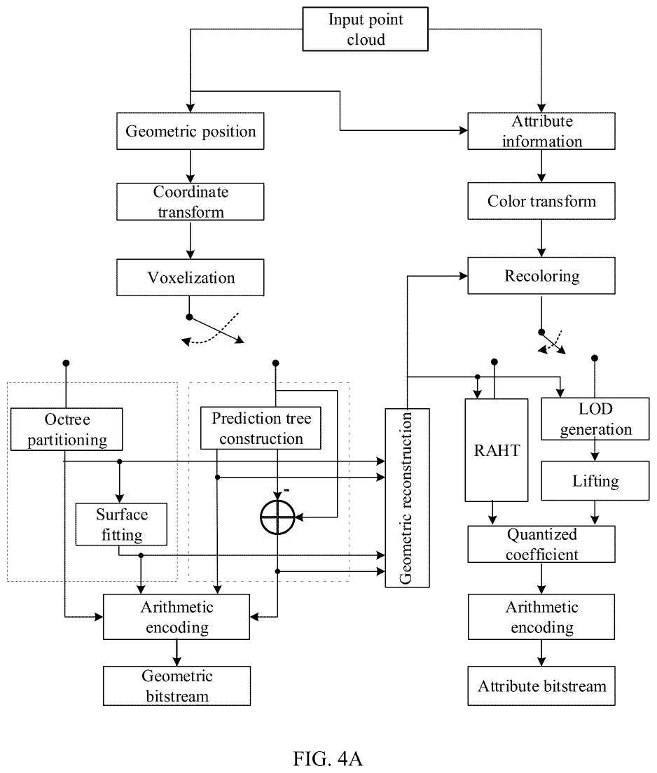

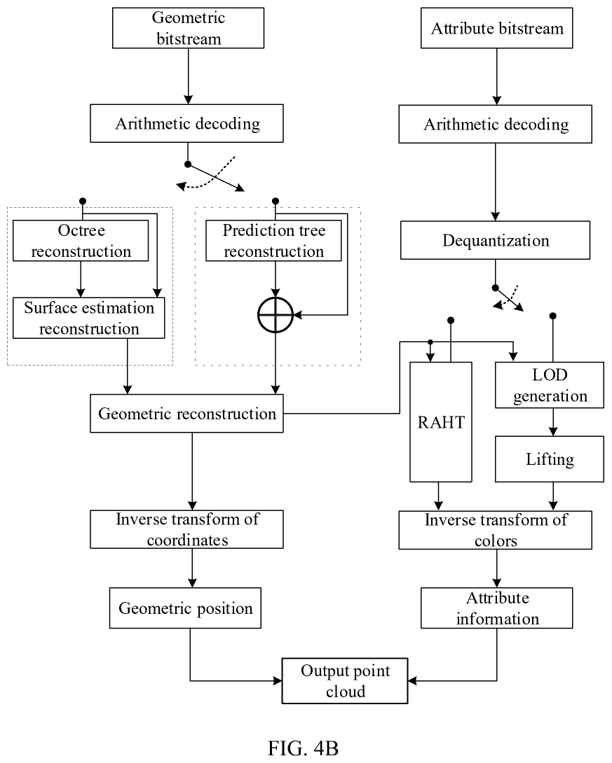

FIG. 4A is a schematic diagram of a framework of a G-PCC encoder. As shown in FIG. 4A, in a geometry encoding process, coordinate transform is performed on geometric information, so that an entire point cloud is included in a bounding box (Bounding Box), and then quantization is performed. The quantization in this step mainly plays a role of scaling. Due to rounding in the quantization, a part of the point cloud has same geometric information. Then, whether to remove duplicate points is determined based on a parameter. The process of quantization and removal of duplicate points is also referred to as voxelization. Next, octree partitioning or prediction tree construction is performed on the bounding box. In this process, arithmetic encoding is performed on points in leaf nodes generated by partitioning, to generate a binary geometric bitstream; or arithmetic encoding (surface fitting based on vertices) is performed on vertices (Vertex) generated by partitioning, to generate a binary geometric bitstream. In an attribute encoding process, geometry encoding is already completed. After the geometric information is reconstructed, color transform needs to be performed first, to transform color information (that is, attribute information) from an RGB color space to a YUV color space. Then, the point cloud is colored again by using the reconstructed geometric information, so that attribute information that is not encoded corresponds to the reconstructed geometric information. Attribute encoding is mainly performed on color information. In a process of encoding the color information, there are mainly two transform methods. One method is distance-based enhanced transform that depends on level of detail (Level of Detail, LOD) division, and the other method is to directly perform region adaptive hierarchal transform (Region Adaptive Hierarchal Transform, RAHT). In both methods, the color information is transformed from a spatial domain to a frequency domain, to obtain a high frequency coefficient and a low frequency coefficient. Finally, the coefficients are quantized to obtain quantized coefficients, and then arithmetic encoding is performed on the quantized coefficients to generate a binary attribute bitstream.

FIG. 4B is a schematic diagram of a framework of a G-PCC decoder. As shown in FIG. 4B, for an acquired binary bitstream, a geometric bitstream and an attribute bitstream in the binary bitstream are first separately decoded. During decoding of the geometric bitstream, geometric information of the point cloud is obtained through arithmetic decoding—octree reconstruction or prediction tree reconstruction—geometric reconstruction—inverse transform of coordinates. During decoding of the attribute bitstream, attribute information of the point cloud is obtained through arithmetic decoding—dequantization—LOD division or RAHT—inverse transform of colors. Based on the geometric information and the attribute information, to-be-encoded point cloud data is restored (that is, the point cloud is outputted).

It should be noted that, as shown in FIG. 4A or FIG. 4B, currently G-PCC geometry encoding and decoding may include octree geometry encoding and decoding (shown in a dashed box) and predictive geometry encoding and decoding (shown in a dash-dotted box).

Octree geometry encoding (OctGeomEnc) includes the following steps. First, coordinate transform is performed on geometric information, so that an entire point cloud is included in a bounding box. Then, quantization is performed. The quantization in this step mainly plays a role of scaling. Due to rounding in the quantization, some points have same geometric information. Then, whether to remove duplicate points is determined based on a parameter. The process of quantization and removal of duplicate points is also referred to as voxelization. Next, partitioning of a tree (for example, an octree, a quadtree, or a binary tree) is continuously performed on the bounding box in a breadth-first traversal sequence, and an occupancy code of each node is encoded. In a related technology, a company proposes an implicit geometric partitioning manner. First, a bounding box (2^{d}^{ₓ}, 2^{d}^{_{y}}, 2^{d}^{_{z}}) of a point cloud is calculated. It is assumed that dₓ>d_{y}>d_{z}, and the bounding box is correspondingly a cube. During geometric partitioning, first, binary tree partitioning is continuously performed based on an x-axis, to obtain two child nodes. Only when a condition dₓ=d_{y}>d_{z} is met, quadtree partitioning is continuously performed based on the x-axis and a y-axis, to obtain four child nodes. When a condition dₓ==d_{z} is finally met, octree partitioning is continuously performed until leaf nodes obtained after the partitioning are 1×1×1 unit cubes. Then, points in the leaf nodes are encoded, to generate a binary bitstream. In a process of partitioning based on a binary tree, a quadtree, or an octree, two parameters K and M are introduced. The parameter K indicates a maximum quantity of times of binary tree or quadtree partitioning before octree partitioning, and the parameter M is used to indicate that a side length of a minimum block corresponding to binary tree or quadtree partitioning is 2^{M}. In addition, K and M must meet the following condition: assuming that dₘₐₓ=max (dₓ, d_{y}, d_{z}) and dₘᵢₙ=min (dₓ, d_{y}, d_{z}), the parameter K meets K≥dₘₐₓ−dₘᵢₙ and the parameter M meets M≥dₘᵢₙ. A reason why the parameters K and M meet the foregoing condition is that, in the current implicit geometric partitioning of G-PCC, partitioning manners in descending order of priorities are binary tree partitioning, quadtree partitioning, and octree partitioning. Only when a size of a node block does not meet a condition of binary tree or quadtree partitioning, octree partitioning is continuously performed on the node until leaf nodes of a minimum unit 1×1×1 are obtained. In an octree geometry encoding mode, geometric information of a point cloud may be effectively encoded by using correlation between neighboring points in space. However, for some relatively flat nodes or nodes that have a planar feature, encoding efficiency of the geometric information of the point cloud may be further improved by using plane coding.

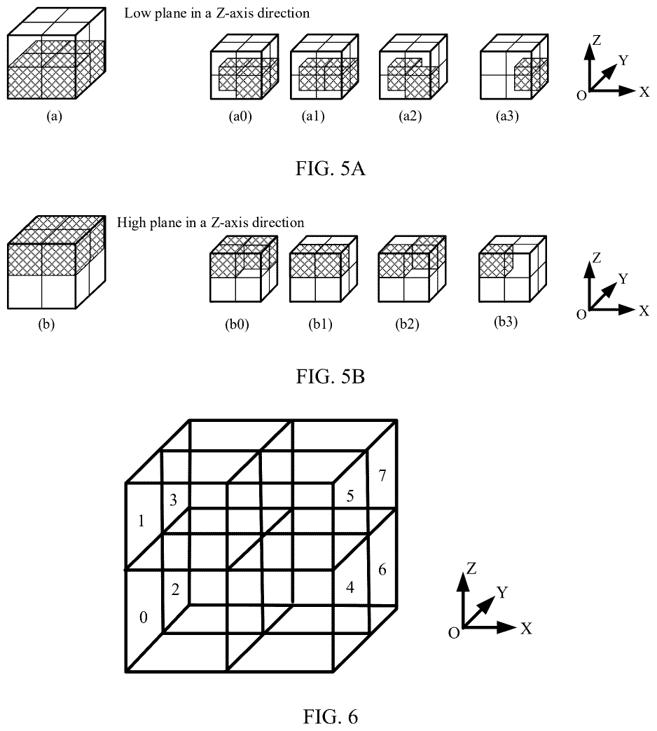

Exemplarily, FIG. 5A and FIG. 5B are schematic diagrams of planar positions. FIG. 5A is a schematic diagram of low planar positions in a Z-axis direction, and FIG. 5B is a schematic diagram of high planar positions in a Z-axis direction. As shown in FIG. 5A, (a), (a0), (a1), (a2), and (a3) herein all belong to low planar positions in a Z-axis direction. By using (a) as an example, it can be seen that four occupied child nodes in a current node are all located in low planar positions in a Z-axis direction of the current node. In this case, it may be considered that the current node belongs to a Z-plane that is a low plane in the Z-axis direction. Similarly, as shown in FIG. 5B, (b), (b0), (b1), (b2), and (b3) herein all belong to high planar positions in a Z-axis direction. By using (b) as an example, it can be seen that four occupied child nodes in a current node are located in high planar positions in a Z-axis direction of the current node. In this case, it may be considered that the current node belongs to a Z-plane that is a high plane in the Z-axis direction.

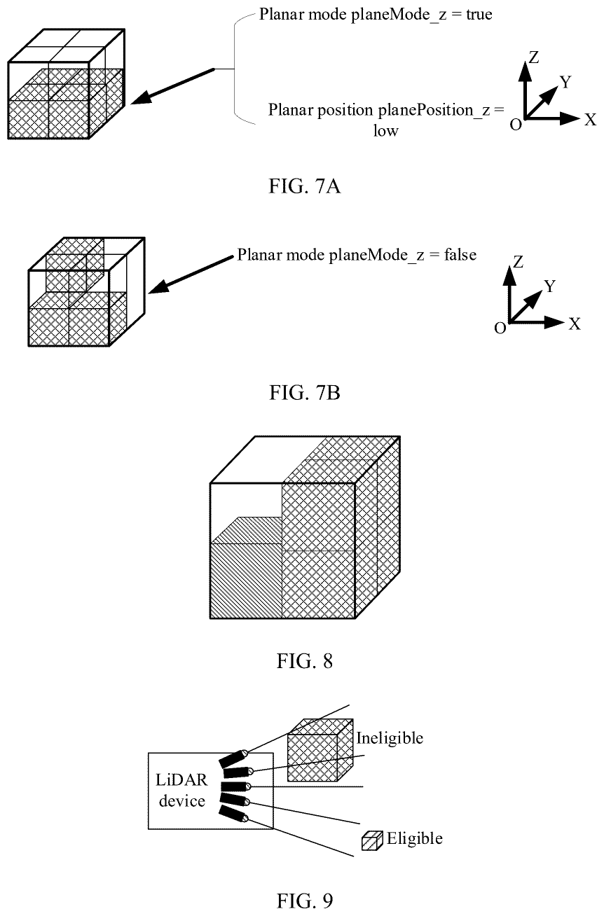

Further, octree coding efficiency is compared against plane coding efficiency by using (a) in FIG. 5A as an example. FIG. 6 is a schematic diagram of a node coding sequence, that is, node coding is performed in a sequence of 0, 1, 2, 3, 4, 5, 6, and 7 shown in FIG. 6. Herein, if octree coding is used for (a) in FIG. 5A, occupancy information of the current node is represented as 11001100. However, if plane coding is used, first, an identifier needs to be encoded, to indicate that the current node is a plane in the Z-axis direction. Then, if the current node is a plane in the Z-axis direction, a planar position of the current node also needs to be represented. Next, only occupancy information (that is, occupancy information of four child nodes 0, 2, 4, and 6) of low-plane nodes in the Z-axis direction needs to be encoded. Therefore, if the current node is encoded based on plane coding, only six bits need to be encoded. Compared with octree coding in a related technology, plane coding reduces representation by two bits. Based on this analysis, plane coding has more evident coding efficiency than octree coding. Therefore, for an occupied node, if plane coding is performed in a dimension, first, planar mode (planarMode) information and planar position (PlanePos) of the current node in the dimension need to be represented. Then, occupancy information of the current node is encoded based on planar information of the current node. Exemplarily, FIG. 7A is a schematic diagram of a piece of planar mode information. As shown in FIG. 7A, a Z-axis direction herein is a low plane. Correspondingly, a value of planar mode information is true or 1, that is, planarMode__{z}=true. A value of planar position information is low, that is, PlanePosition__{z}=low. FIG. 7B is a schematic diagram of another piece of planar mode information. As shown in FIG. 7B, a Z-axis direction herein is not a plane. Correspondingly, a value of planar mode information is false or 0, that is, planarMode__{z}=false.

It should be noted that for PlaneMode_ᵢ, 0 represents that a current node is not a plane in an i-axis direction, and 1 represents that the current node is a plane in the i-axis direction. If the current node is a plane in the i-axis direction, for PlanePosition_ᵢ, 0 indicates that the current node is a plane in the i-axis direction and has a low planar position, and 1 indicates that the current node is a high plane in the i-axis direction. Herein, i represents a coordinate dimension, which may be an X-axis direction, a Y-axis direction, or a Z-axis direction. Therefore, i=0, 1, or 2.

In a G-PCC standard, whether a node meets a plane coding condition is determined. When the node meets the plane coding condition, predictive encoding is performed on planar mode information and planar position information of the node.

In embodiments of this application, there are three conditions for determining whether a node meets a plane coding condition in a current G-PCC standard. The following describes the conditions in detail one by one.

### 1. Determine Whether a Node Meets a Plane Coding Condition Based on a Plane Probability of the Node in Each Dimension.

(1) Determine a local node density (local_node_density) of the current node.
(2) Determine a probability Prob(i) of the current node in each dimension.

When the local node density of the node is less than a threshold value Th (for example, Th=3), a plane probability Pro(i) of the current node in three coordinate dimensions is compared against thresholds Th0, Th1, and Th2, where Th0<Th1<Th2 (for example, Th0=0.6, Th1=0.77, and Th2=0.88). Herein, Eligibleᵢ (i=0,1,2) may be used to indicate whether to enable plane coding in each dimension: Eligibleᵢ

It should be noted that a threshold changes adaptively. For example, when Prob (0)>Prob (1)>Prob (2), Eligible is set as follows:

$${Eligible}_{0} = Prob ( 0 ) \geq Th 0 ;$$

$${Eligible}_{1} = Prob ( 1 ) \geq Th 1 ;$$

$${Eligible}_{2} = Prob ( 2 ) \geq Th 2.$$

When Prob (1)>Prob (0)>Prob (2), Eligible; is set as follows:

$${Eligible}_{0} = Prob ( 0 ) \geq Th 1 ;$$

$${Eligible}_{1} = Prob ( 1 ) \geq Th 0 ;$$

$${Eligible}_{2} = Prob ( 2 ) \geq Th 2.$$

Herein, Prob(i) is updated specifically as follows:

$${Prob ( i )}_{new} = ( L \times Prob ( i ) + δ ( coded node ) ) / L + 1 \qquad ( 1 )$$

Herein, L=255. In addition, if a coded node is a plane, δ(coded node) is 1. Otherwise, δ(coded node) is 0.

Herein, local_node_density is updated specifically as follows:

$$local\_node {\_density}_{new} = local\_node \_density + 4 * numSiblings \qquad ( 2 )$$

Herein, Local_node_density is initialized to 4, and numSiblings is a quantity of sibling nodes of the node. Exemplarily, FIG. 8 is a schematic diagram of sibling nodes of a current node. As shown in FIG. 8, if the current node is a node filled with slanting lines, and nodes filled with grids are sibling nodes, a quantity of the sibling nodes of the current node is 5 (including the current node).

### 2. Determine, Based on a Point Cloud Density of a Current Layer, Whether a Node in the Current Layer Meets a Plane Coding Condition.

A point density of the current layer is used to determine whether to perform plane coding on the node in the current layer. A quantity of points in a currently to-be-encoded point cloud is represented as pointCount, and a quantity of points that have been reconstructed through infer direct coding model (Infer Direct Coding Model, IDCM) coding is represented as numPointCountRecon. In addition, because octree coding is performed based on a breadth-first traversal sequence, a quantity of to-be-encoded nodes in the current layer, which is represented as nodeCount, may be obtained. In this case, whether plane coding is enabled for the current layer is represented as planarEligibleKOctreeDepth, which is determined specifically as planarEligibleKOctreeDepth=(pointCount−numPointCountRecon)<nodeCount×1.3.

If (pointCount−numPointCountRecon) is less than nodeCount×1.3, planarEligibleKOctreeDepth is true, or if (pointCount-numPointCountRecon) is not less than nodeCount×1.3, planarEligibleKOctreeDepth is false. In this way, when planarEligibleKOctreeDepth is true, plane coding is performed on all nodes in the current layer. Otherwise, plane coding is not performed on any node in the current layer, and only octree coding is used.

### 3. Determine, Based on a Collection Parameter of a LiDAR Point Cloud, Whether a Current Node Meets a Plane Coding Condition.

FIG. 9 is a schematic diagram of intersection between lasers of a LiDAR device and a node. As shown in FIG. 9, a grid-filled node is simultaneously passed through by rays of two lasers. Therefore, a current node is not a plane in a vertical Z-axis direction. A node filled with slanting lines is so small that the node cannot be simultaneously passed through by rays of two lasers. Therefore, the node filled with slanting lines may be a plane in the vertical Z-axis direction.

Further, for a node that meets a plane coding condition, predictive encoding may be performed on planar mode information and planar position information.

First, predictive encoding is performed on the planar mode information.

Herein, only three pieces of context information are used for encoding, that is, context is designed separately for a planar mode in each coordinate dimension.

Second, predictive encoding is performed on the planar position information.

It should be understood that, for encoding of planar position information of a non-LiDAR point cloud, predictive encoding of the planar position information may include:
(a) planar position information of the current node that is obtained through prediction by using occupancy information of the neighboring node, which includes three elements, that is, being predicted as a low plane, being predicted as a high plane, and being unpredictable;
(b) the spatial distance between the current node and the node at the same partitioning depth and the same coordinate as the current node, which is “short” or “long”;
(c) a planar position of the node at the same partitioning depth and the same coordinate as the current node, determined if the node is a plane; and
(d) coordinate dimensions (i=0, 1, 2).

It should be noted that, in embodiments of this application, after the spatial distance between the current node and the node under the same division depth and the same coordinates as the current node is determined, if the spatial distance is less than a preset distance threshold, it may be determined that the spatial distance is “short”. Alternatively, if the spatial distance is greater than the preset distance threshold, it may be determined that the spatial distance is “long”.

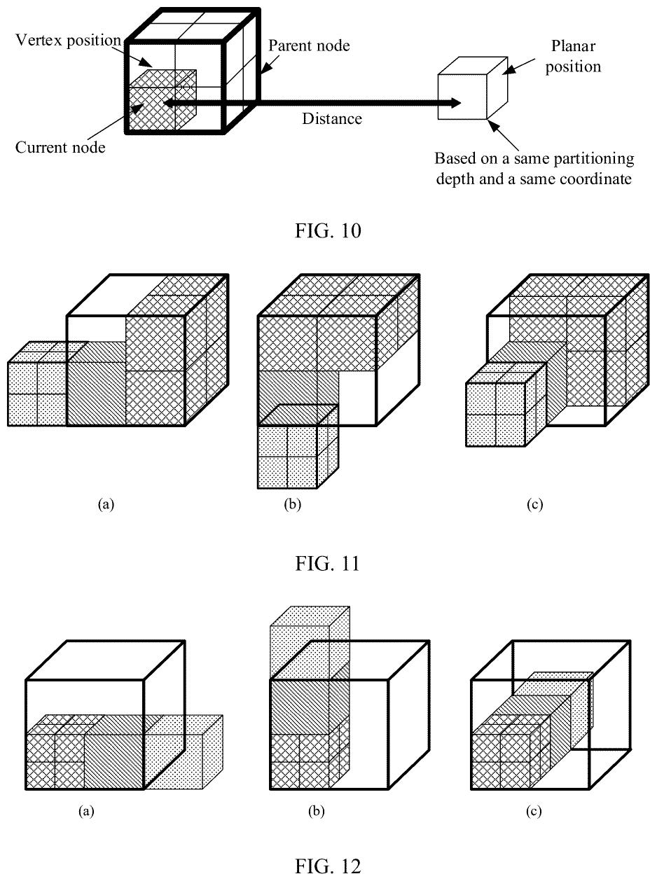

Exemplarily, FIG. 10 is a schematic diagram of a neighboring node at a same division depth and a same coordinate. As shown in FIG. 10, a bold large cube represents a parent node, a grid-filled small cube inside the large cube represents a current node, and a vertex position of the current node is shown. A small cube filled with the white color represents a neighboring node at a same division depth and a same coordinate. A distance between the current node and the neighboring node is a spatial distance, which may be determined as “short” or “long”. In addition, if the neighboring node is a plane, a planar position of the neighboring node is also required.

In this way, as shown in FIG. 10, the current node is a grid-filled small cube, and a neighboring node is searched at a same octree division depth level and a same vertical coordinate. The found neighboring node is a small cube filled with the white color. It is determined that a distance between the two nodes is “short” or “long”, and reference is made to planar positions of the nodes.

Further, in embodiments of this application, FIG. 11 is a schematic diagram showing that a current node is located on a low plane of a parent node. As shown in FIG. 11, (a), (b), and (c) show examples of three cases in which the current node is located on a low plane of the parent node. Detailed descriptions are as follows.
\textcircled{1} If any one of child nodes 4 to 7 of a point-filled node is occupied, and none of grid-filled nodes is occupied, it is very likely that a plane exists in the current node (filled with slanting lines), and a position of the plane is relatively low.
\textcircled{2} If none of child nodes 4 to 7 of a point-filled node is occupied, and all grid-filled nodes are occupied, it is very likely that a plane exists in the current node (filled with slanting lines), and a position of the plane is relatively high.
\textcircled{3} If all child nodes 4 to 7 of a point-filled node are empty nodes, and all grid-filled nodes are empty nodes, a position of the plane cannot be inferred and therefore is marked as unknown.
\textcircled{4} If any one of child nodes 4 to 7 of a point-filled node is occupied, and any one of grid-filled nodes is occupied, a position of the plane cannot be inferred and therefore is marked as unknown.

In embodiments of this application, FIG. 12 is a schematic diagram showing that a current node is located on a high plane of a parent node. As shown in FIG. 12, (a), (b), and (c) show examples of three cases in which the current node is located on a high plane of the parent node. Detailed descriptions are as follows.
\textcircled{1} If any one of child nodes 4 to 7 of a grid-filled node is occupied, and a point-filled node is not occupied, it is very likely that a plane exists in the current node (filled with slanting lines), and a position of the plane is relatively low.
\textcircled{2} If none of child nodes 4 to 7 of a grid-filled node is not occupied, and a point-filled node is occupied, it is very likely that a plane exists in the current node (filled with slanting lines), and a position of the plane is relatively high.
\textcircled{3} If none of child nodes 4 to 7 of a grid-filled node is not occupied, and a point-filled node is not occupied, a position of the plane cannot be inferred and therefore is marked as unknown.
\textcircled{4} If one of child nodes 4 to 7 of a grid-filled node is occupied, and a point-filled node is occupied, a position of the plane cannot be inferred and therefore is marked as unknown.

It should be further understood that, for encoding of planar position information of a LiDAR point cloud, FIG. 13 is a schematic diagram of predictive encoding of planar position information of a LiDAR point cloud. As shown in FIG. 13, a case in which an emission angle of a LiDAR device is θ_{bottom} may be mapped to a bottom plane (Bottom virtual plane), or a case in which the emission angle of the LiDAR device is θₜₒₚ may be mapped to a top plane (Top virtual plane).

That is, a planar position of a current node is predicted by using a collection parameter of the LiDAR device. Then, the position is quantized into a plurality of intervals by using a position at which the current node intersects a laser ray, and finally serves as context information of the planar position of the current node. A specific calculation process is as follows. Assuming that coordinates of the LiDAR device are (x_{Lidar}, y_{Lidar}, z_{Lidar}) and geometric coordinates of the current node are (x, y, z), first, a vertical tangent value tan δ of the current node relative to the LiDAR device is calculated by using the following formula:

$$tan θ = \frac{Lidar}{y - y} \qquad ( 3 )$$

Further, because each laser has a deflection angle relative to the LiDAR device, a relative tangent value tan θ_{corr,L} of the current node relative to the laser also needs to be calculated. A calculation manner is as follows:

$$tan {θ}_{corr , L} = \text{?} = tan θ - \text{?} \qquad ( 4 )$$

$$\text{?} \text{indicates text missing or illegible when filed}$$

Finally, the relative tangent value tan θ_{corr,L} of the current node is used to predict the planar position of the current node. Specifically, it is assumed that a tangent value of a lower boundary of the current node is tan (θ_{bottom}), and a tangent value of an upper boundary of the current node is tan (θₜₒₚ). The planar position is quantized into four quantization intervals according to tan θ_{corr,L}, that is, context information of the planar position is determined.

However, the octree geometry encoding mode has an efficient compression rate only for points that are correlated in space. For a point that is in an isolated position in a geometric space, complexity may be greatly reduced by using a direct coding model (Direct Coding Model, DCM). For all nodes in an octree, usage of the DCM is not represented by flag information, but is inferred by using information about a parent node and a neighbor of a current node. Whether the current node is eligible for DCM coding is determined in the following three manners.
(1) The current node has no sibling nodes, that is, the parent node of the current node has only one child node, and a parent node of the parent node of the current node has only two occupied child nodes, that is, the current node has a maximum of one neighboring node.
(2) The parent node of the current node has only one occupied child node, that is, the current node, and six neighboring nodes that each share a face with the current node are all empty nodes.
(3) A quantity of sibling nodes of the current node is greater than 1.

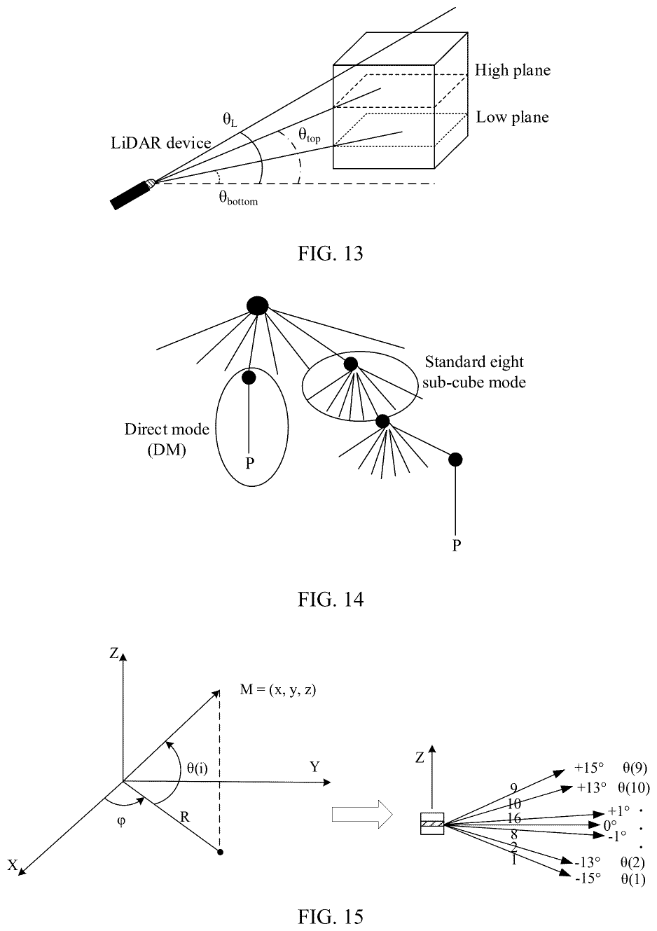

Exemplarily, FIG. 14 is a schematic diagram of IDCM coding. If a current node is not eligible for DCM coding, octree partitioning is performed on the current node. If the current node is eligible for DCM coding, a quantity of points included in the node is further determined. If the quantity of points is less than a threshold (for example, 2), DCM coding is performed on the node. Otherwise, octree partitioning is continued. When the DCM coding mode is applied, first, it needs to be encoded whether the current node is a real isolated point, that is, IDCM_flag. When IDCM_flag is true, DCM coding is used for the current node. Otherwise, octree coding is still used. When the current node meets a DCM coding condition, a DCM coding mode needs to be encoded for the current node. Currently, there are two DCM modes: (a) There is only one point (or a plurality of points that are duplicate points); (b) There are two points. Finally, geometric information of each point needs to be encoded. Assuming that a side length of the node is 2^{d}, d bits are required for encoding each component of geometric coordinates of the node, and the bit information is directly encoded into a bitstream. It should be noted herein that, when a LiDAR point cloud is encoded, predictive encoding is performed on coordinate information in three dimensions by using a LiDAR collection parameter, thereby further improving encoding efficiency of geometric information.

Further, the following describes in detail an IDCM coding process.

When a current node meets a DCM coding model, first, a quantity numPoints of points in the current node is encoded according to different values of DirectMode.
(1) If the current node does not meet a requirement of a DCM node, the encoding is not performed (that is, the quantity of points is greater than 2 and the points are not duplicate).
(2) If the quantity numPoints of the points included in the current node is less than or equal to 2, the encoding process is as follows.
i) First, whether numPoints of the current node is greater than 1 is encoded.
ii) If the current node has only one point and a geometric coding environment is geometric lossless coding, that the second point of the current node is not a duplicate point needs to be encoded.
(3) If the quantity numPoints of the points included in the current node is greater than 2, the encoding process is as follows.
i) First, that numPoints of the current node is less than or equal to 1 is encoded.
ii) Then, that the second point of the current node is a duplicate point is encoded, and whether a quantity of duplicate points in the current node is greater than 1 is encoded. If the quantity of the duplicate points is greater than 1, exponential-Golomb decoding needs to be performed on a quantity of remaining duplicate points.

After the quantity of the points in the current node is encoded, coordinate information of the points included in the current node is encoded. The following separately describes a LiDAR point cloud and a human eye point cloud.

1. For a human eye point cloud:
(1) If a current node includes only one point, bypass encoding (Bypass coding) is performed on geometric information in three dimensions of the point.
(2) If a current node includes two points, first, a preferentially encoded coordinate axis dirextAxis is obtained by using geometric coordinates of the points. It should be noted herein that currently compared coordinate axes include only an x-axis and a y-axis, and do not include a z-axis. Assuming that geometric coordinates of the current node are nodePos, a manner of determining is as follows:

$$dirextAxis = ! ( nodePos [ 0 ] < nodePos [ 1 ] ) \qquad ( 5 )$$

That is, an axis with a small geometric coordinate position of the node is used as the preferentially encoded coordinate axis dirextAxis. Then, geometric information of the preferentially encoded coordinate axis dirextAxis is first encoded in the following manner. It is assumed that a to-be-encoded geometry bit depth corresponding to the preferentially encoded axis is nodeSizeLog2, and coordinates of the two points are respectively pointPos[0] and pointPos[1]. A specific encoding process is as follows:

```
  Bool sameBit=true;
  while(nodeSizeLog2&& sameBit){
    int mask=1<< nodeSizeLog2;
    −−nodeSizeLog2;
    bool bit0=!!( pointPos[0]& mask)
bool bit1=!!( pointPos[1]& mask)
    sameBits=bit0==bit1;
    entropyCodeSameBit(sameBits); ///<entropy coding
    if(sameBits)
      encodePosBit(bit0);///<Bypass coding
    }
```

After the preferentially encoded coordinate axis dirextAxis is encoded, bypass encoding is performed on the geometric coordinates of the current node. Assuming that a remaining coding bit depth of each point is nodeSizeLog2, a specific encoding process is as follows:

for(int axisIdx=0;axisIdx<3;++axisIdx)
for(int mask=(1<< nodeSizeLog2[axisIdx])>>1;mask;mask>>1)
encodePosBit(!!(pointPos[axisIdx]&mask)).

### 2. For a LiDAR Point Cloud:

If a current node includes two points, first, a preferentially encoded coordinate axis dirextAxis is obtained by using geometric coordinates of the points. It is assumed that geometric coordinates of the current node are nodePos, and a manner of determining is as follows:

$$dirextAxis = ! ( nodePos [ 0 ] < nodePos [ 1 ] )$$

That is, an axis with a small geometric coordinate position of the node is used as the preferentially encoded coordinate axis dirextAxis. It should be noted herein that currently compared coordinate axes include only an x-axis and a y-axis, and do not include a z-axis. Then, geometric information of the preferentially encoded coordinate axis dirextAxis is first encoded in the following manner. It is assumed that a to-be-encoded geometry bit depth corresponding to the preferentially encoded axis is nodeSizeLog2, and coordinates of the two points are respectively pointPos[0] and pointPos[1]. A specific encoding process is as follows:

```
  Bool sameBit=true;
  while(nodeSizeLog2&& sameBit){
    int mask=1<< nodeSizeLog2;
    −−nodeSizeLog2;
    bool bit0=!!( pointPos[0]& mask)
bool bit1=!!( pointPos[1]& mask)
    sameBits=bit0==bit1;
    entropyCodeSameBit(sameBits);
    if(sameBits)
      encodePosBit(bit0);
    }
```

After the preferentially encoded coordinate axis dirextAxis is encoded, the geometric coordinates of the current node are encoded.

A LiDAR point cloud may obtain a collection parameter of the LiDAR point cloud, and geometric coordinate information of the current node may be predicted by using the collection parameter, thereby further improving encoding efficiency of geometric information of the point cloud. Similarly, first, a principal direction in which bypass encoding is performed is obtained by using geometric information nodePos of the current node, and then geometric information of a direction in which encoding is completed is used to perform predictive encoding on geometric information of another dimension. Similarly, assuming that an axial direction in which bypass encoding is performed is directAxis and a to-be-encoded bit depth in the bypass encoding is nodeSizeLog2, an encoding manner is as follows:

for(int mask=(1<< nodeSizeLog2)>>1;mask;mask>>1);
encodePosBit(!!(pointPos[directAxis]&mask)).

It should be noted herein that all geometric precision information in the direction directAxis is encoded herein.

Exemplarily, FIG. 15 is a schematic diagram of coordinate transform of a point cloud acquired by a rotating LiDAR device. In a Cartesian coordinate system, coordinates (x, y, z) of each node can be transformed into coordinates (R, φ, i). In addition, a laser scanner (Laser Scanner) can perform laser scanning at a preset angle. Different values of i yield different θ(i). For example, when i is equal to 1, θ(1) can be obtained, and a corresponding scanning angle is −15°. When i is equal to 2, θ(2) can be obtained, and a corresponding scanning angle is −13°. When i is equal to 10, θ(10) can be obtained, and a corresponding scanning angle is +13°. When i is equal to 19, θ(19) can be obtained, and a corresponding scanning angle is +15°.

In this case, after all precision values in a coordinate direction directAxis are encoded, first, LaserIdx corresponding to a current point, that is, pointLaserIdx in FIG. 15, is calculated, and LaserIdx of a current node, that is, nodeLaserIdx, is calculated. Then, LaserIdx of the node, that is, nodeLaserIdx, is used to perform predictive encoding on LaserIdx of the point, that is, pointLaserIdx. LaserIdx of the node or the point is calculated in the following manner: Assuming that a geometric coordinate of a point is pointPos, a start coordinate of a laser ray is LidarOrigin, a quantity of Laser is LaserNum, a tangent value of each Laser is tanθᵢ, and an offset position of each Laser in a vertical direction is Zᵢ,

```
  Int bestLaserIdx=0;
  Int Distoration=INT_MAX;
For(int LaserIdx=0; LaserIdx<numLaser;++ LaserIdx){
  int radius
  =
  int invRadius=1/ radius
  int Z=pointPos[2]+ Zᵢ
  int tanTheta= Z×invRadius
  if(std::abs(tanTheta−tanθᵢ)< Distoration){
    Distoration= std::abs(tanTheta−tanθᵢ);
    bestLaserIdx= LaserIdx;
    }
  }
```

After LaserIdx of the current point is calculated, first, predictive encoding is performed on pointLaserIdx of the point by using LaserIdx of the current node. After LaserIdx of the current point is encoded, predictive encoding is performed on geometric information of three dimensions of the current point by using a collection parameter of the LiDAR device.

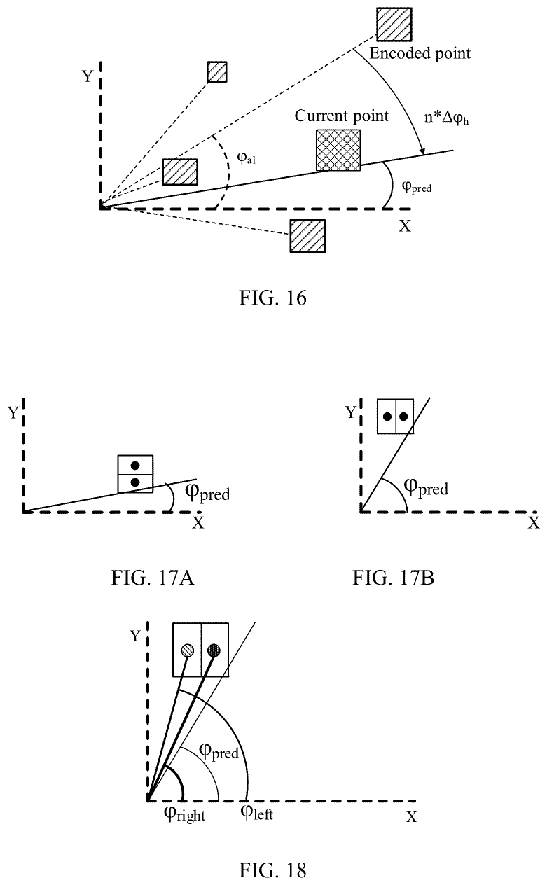

Exemplarily, FIG. 16 is a schematic diagram of predictive encoding in an X-axis or Y-axis direction. As shown in FIG. 16, a grid-filled box represents a current point, and a box filled with slanting lines represents an encoded point (Already coded node). Herein, first, a predicted value, that is, φ_{pred}, of a corresponding horizontal azimuth is obtained by using LaserIdx corresponding to a current point, and then a horizontal azimuth φ_{node} corresponding to a node corresponding to the current point is obtained by using geometric information of the node. Assuming that the geometric coordinates of the node are nodePos, a manner of calculating a horizontal azimuth φ by using the geometric information of the node is as follows:

$$φ = arctan ( nodePos [ 1 ] / nodePos [ 0 ] ) \qquad ( 6 )$$

The collection parameter of the LiDAR device may be used to obtain a quantity numPoints of rotation points of each laser, that is, a quantity of points obtained after each laser ray rotates by one circle. In this case, the quantity of rotation points of each laser may be used to calculate a rotational angular velocity deltaPhi of each laser. A calculation manner is as follows:

$$deltaPhi = \frac{2 π}{numPoints} \qquad ( 7 )$$

Further, the horizontal azimuth @node of the node and a horizontal azimuth φ_{pred} of a previous encoding point of a laser corresponding to the current point are used to calculate a predicted value φ_{predPoint} of the horizontal azimuth corresponding to the current point, for example, a predicted value of a horizontal azimuth in FIG. 17A and FIG. 17B. FIG. 17A is a schematic diagram of an angle for predicting a Y plane by using a horizontal azimuth, and FIG. 17B is a schematic diagram of an angle for predicting an X plane by using a horizontal azimuth. Herein, the predicted value φ_{predPoint} of the horizontal azimuth corresponding to the current point is calculated as follows:

$${φ}_{predPoint} = \frac{φ pred - φ node}{deltaPhi} \times deltaPhi + φ pred \qquad ( 8 )$$

Exemplarily, FIG. 18 is another schematic diagram of predictive encoding in an X-axis or Y-axis direction. As shown in FIG. 18, a grid-filled part (on the left) represents a low plane, a dot-filled part (on the right) represents a high plane, φ_{left} represents a low-plane horizontal azimuth of a current node, φ_{right} represents a high-plane horizontal azimuth of the current node, and φ_{pred} represents a predicted value of a horizontal azimuth corresponding to the current node.

In this way, predictive encoding is performed on geometric information of the current node by using the predicted value φ_{redPoint} of the horizontal azimuth, the low-plane horizontal azimuth φ_{left} of the current node, and the high-plane horizontal azimuth φ_{right} of the current node. Details are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) ‖ ( angLel < 0 \&\& angLeR < ) ? 0 : 2 ;$$

$$int min Angle = std ∷ min ( abs ( angLel ) , abs ( angLeR ) ) ;$$

$$int max Angle = std ∷ max ( abs ( angLel ) , abs ( angLeR ) ) ;$$

$$context += max Angle > min Angle ? 0 : 1 ;$$

$$context += max Angle > min Angle ? 0 : 4.$$

After LaserIdx of a point is encoded, predictive encoding is performed on a Z-axis direction of the current point by using LaserIdx corresponding to the current point. That is, currently, depth information radius of a radar coordinate system is calculated by using x and y information of the current point. Then, a tangent value of the current point and an offset in a vertical direction are obtained by using LaserIdx of the current point. In this case, a predicted value, that is, Z_pred, of the current point in the Z-axis direction may be obtained. Details are as follows:

$$int radius = \text{?}$$

$$int tan Theta = tan {θ}_{laserIdx} ;$$

$$int zOffset = {Z}_{laserIdx} ;$$

$$Z\_pred = radius \times tan Theta - zOffset .$$

$$\text{?} \text{indicates text missing or illegible when filed}$$

Further, Z_pred is used to perform predictive encoding on geometric information in the Z-axis direction of the current point, to obtain a prediction residual Z_res, and Z_res is encoded.

It should be noted that, when a node is divided into leaf nodes, in a case of lossless geometry encoding, a quantity of duplicate points in the leaf nodes needs to be encoded. Finally, occupancy information of all nodes is encoded to generate a binary bitstream. In addition, currently a plane coding mode is introduced into G-PCC. In a process of geometric partitioning, it is determined whether child nodes of a current node are on a same plane. If the child nodes of the current node meet a condition of being on the same plane, the plane is used to represent the child nodes of the current node.

For octree geometry decoding, in a breadth-first traversal sequence, before decoding occupancy information of each node, the decoding end first determines, by using reconstructed geometric information, whether to perform planar decoding or IDCM decoding on a current node. If the current node meets a condition of planar decoding, the decoding end first decodes planar mode information and planar position information of the current node, and then decodes, based on planar information, occupancy information of the current node. If the current node meets a condition of IDCM decoding, the decoding end first decodes whether the current node is a real IDCM node. If the current node is a real IDCM node, the decoding end parses a DCM decoding mode of the current node, and then may obtain a quantity of points in the current DCM node. Finally, the decoding end decodes geometric information of each point. For a node that meets neither plane decoding nor DCM decoding, occupancy information of the current node is decoded. In this manner, an occupancy code of each node is obtained through continuous parsing, and nodes are successively divided until 1×1×1 unit cubes are obtained. A quantity of points included in each leaf node is obtained through parsing, and finally, reconstructed geometric information of a point cloud is restored.

The following describes a process of IDCM decoding in detail.

The processing is similar to encoding. First, priori information is used to determine whether an IDCM is enabled for a node. That is, a condition for enabling the IDCM is as follows:
(1) The current node has no sibling nodes, that is, the parent node of the current node has only one child node, and a parent node of the parent node of the current node has only two occupied child nodes, that is, the current node has a maximum of one neighboring node.
(2) The parent node of the current node has only one occupied child node, that is, the current node, and six neighboring nodes that each share a face with the current node are all empty nodes.
(3) A quantity of sibling nodes of the current node is greater than 1.

Further, when the node meets a DCM coding condition, first, whether the current node is a real DCM node, that is, IDCM_flag, is decoded. When IDCM_flag is true, DCM coding is used for the current node. Otherwise, octree coding is still used.

Then, a quantity numPoints of points of the current node is decoded. A specific decoding manner is as follows.
i) First, whether numPoints of the current node is greater than 1 is decoded.
ii) If it is obtained through the decoding that numPoints of the current node is greater than 1, whether the second point is a duplicate point is decoded. If the second point is not a duplicate point, it may be implicitly deduced herein that the second type of the DCM mode is met, that is, only two points are included.
iii) If it is obtained through the decoding that numPoints of the current node is less than or equal to 1, whether the second point is a duplicate point is decoded. If the second point is not a duplicate point, it may be implicitly deduced herein that the second type of the DCM mode is met, that is, only one point is included. If it is obtained through the decoding that the second point is a duplicate point, it may be inferred that the third type of the DCM mode is met, that is, a plurality of points are included but are all duplicate points. In this case, whether a quantity of the duplicate points is greater than 1 is decoded (entropy decoding). If the quantity is greater than 1, a quantity of remaining duplicate points is decoded (exponential-Golomb decoding).

If the current node does not meet a requirement of a DCM node, the encoding is not performed (that is, the quantity of points is greater than 2 and the points are not duplicate).

After the quantity of the points in the current node is decoded, coordinate information of the points included in the current node is decoded. The following separately describes a LiDAR point cloud and a human eye point cloud.

1. For a human eye point cloud:
(1) If a current node includes only one point, bypass decoding is performed on geometric information in three dimensions of the point.
(2) If the current node includes two points, first, a preferentially decoded coordinate axis dirextAxis is obtained by using geometric coordinates of the points. It should be noted herein that currently compared coordinate axes include only an x-axis and a y-axis, and do not include a z-axis. Assuming that geometric coordinates of the current node are nodePos, a manner of determining is as follows:

$$dirextAxis = ! ( nodePos [ 0 ] < nodePos [ 1 ] ) \qquad ( 9 )$$

That is, an axis with a small geometric coordinate position of the node is used as the preferentially decoded coordinate axis dirextAxis. Then, geometric information of the preferentially decoded coordinate axis dirextAxis is first decoded in the following manner. It is assumed that a to-be-decoded geometry bit depth corresponding to the preferentially decoded axis is nodeSizeLog2, and coordinates of the two points are respectively pointPos[0] and pointPos[1]. A specific encoding process is as follows:

```
Bool sameBit=true;
while(nodeSizeLog2&& sameBit){
  pointPos[0][ dirextAxis]<<1;
  pointPos[1][ dirextAxis]<<1;
  −−nodeSizeLog2;
    int bit=0;
      deEntropyCodeSameBit(sameBits); ///<entropy coding
    if(sameBits){
        bit =decodePosBit( );///<Bypass coding
        pointPos[0][ dirextAxis]|= bit
        pointPos[1][ dirextAxis]|= bit
    }else
            pointPos[1][ dirextAxis]|= 1///< Because the two points are
          sorted in a direction of a preferentially encoded axis during
          encoding, pointPos[0][dirextAxis] < pointPos[1][dirextAxis] may
          be ensured. Therefore, during decoding, if bit information of the
          two points is different, it may be inferred that a bit of the first point
          is 0 and a bit of the second point is 1.
    }
```

After the preferentially decoded coordinate axis dirextAxis is decoded, bypass decoding is performed on the geometric coordinates of the current point. Assuming that a remaining coding bit depth of each point is nodeSizeLog2, and assuming that coordinate information of the point is pointPos, a specific decoding process is as follows:

```
for(int axisIdx=0;axisIdx<3;++axisIdx)
for(int idx= nodeSizeLog2[axisIdx]; idx; idx−−){
  pointPos[axisIdx]<<1;
  pointPos[axisIdx]|=decodePosBit( );
    }
```

### 2. For a LiDAR Point Cloud:

If a current node includes two points, first, a preferentially decoded coordinate axis dirextAxis is obtained by using geometric coordinates of the points. It is assumed that geometric coordinates of the current node are nodePos, and a manner of determining is as follows:

$$dirextAxis = ! ( nodePos [ 0 ] < nodePos [ 1 ] ) \qquad ( 10 )$$

That is, an axis with a small geometric coordinate position of the node is used as the preferentially decoded coordinate axis dirextAxis. It should be noted herein that currently compared coordinate axes include only an x-axis and a y-axis, and do not include a z-axis. Then, geometric information of the preferentially encoded coordinate axis dirextAxis is first decoded in the following manner. It is assumed that a to-be-encoded geometry bit depth corresponding to the preferentially decoded axis is nodeSizeLog2, and coordinates of the two points are respectively pointPos[0] and pointPos[1]. A specific encoding process is as follows:

```
Bool sameBit=true;
while(nodeSizeLog2&& sameBit){
  pointPos[0][ dirextAxis]<<1;
  pointPos[1][ dirextAxis]<<1;
    −−nodeSizeLog2;
    int bit=0;
      deEntropyCodeSameBit(sameBits); ///<entropy coding
    if(sameBits){
        bit =decodePosBit( );///<Bypass coding
        pointPos[0][ dirextAxis]|= bit
        pointPos[1][ dirextAxis]|= bit
    }else
            pointPos[1][ dirextAxis]|= 1///< Because the two points are
          sorted in a direction of a preferentially encoded axis during
          encoding, pointPos[0][dirextAxis] < pointPos[1][dirextAxis] may
          be ensured. Therefore, during decoding, if bit information of the
          two points is different, it may be inferred that a bit of the first point
          is 0 and a bit of the second point is 1.
    }
```

After the preferentially decoded coordinate axis dirextAxis is decoded, the geometric coordinates of the current point are decoded.

Similarly, first, a principal direction in which bypass decoding is performed is obtained by using geometric information nodePos of the current node, and then geometric information of a direction in which decoding is completed is used to decode geometric information of another dimension. Similarly, assuming that an axial direction in which bypass decoding is performed is directAxis and a to-be-decoded bit depth in the bypass decoding is nodeSizeLog2, a decoding manner is as follows:

```
for(int idx= nodeSizeLog2[directAxis]; idx; idx−−){
  pointPos[directAxis]<<1;
  pointPos[directAxis]|=decodePosBit( );
    }
```

It should be noted herein that all geometric precision information in the direction directAxis is decoded herein.

After all precision values in a coordinate direction directAxis are decoded, first, LaserIdx of a current node, that is, nodeLaserIdx, is calculated. Then, LaserIdx of the node, that is, nodeLaserIdx, is used to perform predictive decoding on LaserIdx of a point, that is, pointLaserIdx. LaserIdx of the node or the point is calculated in the same manner as the encoding end. Finally, prediction residual information of LaserIdx of the current point and prediction residual information of LaserIdx of the node are decoded, to obtain ResLaserIdx. A decoding manner is as follows:

$$PointLaserIdx = nodeLaserIdx + ResLaserIdx \qquad ( 11 )$$

After LaserIdx of the current point is decoded, predictive decoding is performed on geometric information of three dimensions of the current point by using a collection parameter of the LiDAR device. A specific algorithm is as follows.

As shown in FIG. 11, first, a predicted value, that is, φ_{pred}, of a corresponding horizontal azimuth is obtained by using LaserIdx corresponding to a current point, and then a horizontal azimuth φ_{node} corresponding to a node corresponding to the current point is obtained by using geometric information of the node. Assuming that the geometric coordinates of the node are nodePos, a manner of calculating a horizontal azimuth φ by using the geometric information of the node is as follows:

$$φ = arctan ( nodePos [ 1 ] / nodePos [ 0 ] ) \qquad ( 12 )$$

The collection parameter of the LiDAR device may be used to obtain a quantity numPoints of rotation points of each laser, that is, a quantity of points obtained after each laser ray rotates by one circle. In this case, the quantity of rotation points of each laser may be used to calculate a rotational angular velocity deltaPhi of each laser. A calculation manner is as follows:

$$deltaPhi = \frac{2 π}{numPoints} \qquad ( 13 )$$

Further, the horizontal azimuth φ_{node} of the node and a horizontal azimuth φ_{pred} of a previous encoding point of a laser corresponding to the current point are used to calculate a predicted value φ_{predPoint} of the horizontal azimuth corresponding to the current point, for example, a predicted value of a horizontal azimuth in FIG. 17A and FIG. 17B. A calculation manner is as follows:

$$\text{?} = \text{?} \times deltaPhi + φ pred \qquad ( 14 )$$

$$\text{?} \text{indicates text missing or illegible when filed}$$

In this way, predictive decoding is performed on geometric information of the current node by using the predicted value φ_{predPoint} of the horizontal azimuth, the low-plane horizontal azimuth φ_{left} of the current node, and the high-plane horizontal azimuth φ_{right} of the current node. Details are as follows:

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 ) ‖ ( angLel < 0 \&\& angLeR < ) ? 0 : 2 ;$$

$$int abs AngleL = abs ( angLel ) ;$$

$$int abs AngleR = abs ( angLeR ) ;$$

$$context += abs AngleL > abs AngleR ? 0 : 1 ;$$

$$context += max Angle > min Angle ≪ 1 ? 4 : 0.$$

After LaserIdx of a point is decoded, predictive decoding is performed on a Z-axis direction of the current point by using LaserIdx corresponding to the current point. That is, currently, depth information radius of a radar coordinate system is calculated by using x and y information of the current point. Then, a tangent value of the current point and an offset in a vertical direction are obtained by using LaserIdx of the current point. In this case, a predicted value, that is, Z_pred, of the current point in the Z-axis direction may be obtained. Details are as follows:

$$int radius = \text{?}$$

$$int tan Theta = tan {θ}_{laserIdx} ;$$

$$int zOffset = {Z}_{laserIdx} ;$$

$$Z\_pred = radius \times tan Theta - zOffset .$$

$$\text{?} \text{indicates text missing or illegible when filed}$$

Further, Z_res and Z_pred that are obtained through the decoding are used to reconstruct and restore geometric information in the Z-axis direction of the current point.

For geometric information encoding based on a triangle soup (trisoup), geometric partitioning needs to be performed first in a geometric information encoding framework based on a trisoup. However, different from that in geometric information encoding based on a binary tree, a quadtree, or an octree, in this method, a point cloud does not need to be divided into unit cubes with side lengths of 1×1×1, but is divided until a block with a side length of W is obtained. Based on a surface formed by point clouds in each block, a maximum of twelve vertices generated by the surface and twelve edges of the block are obtained. Vertex coordinates of each block are successively encoded to generate a binary bitstream.

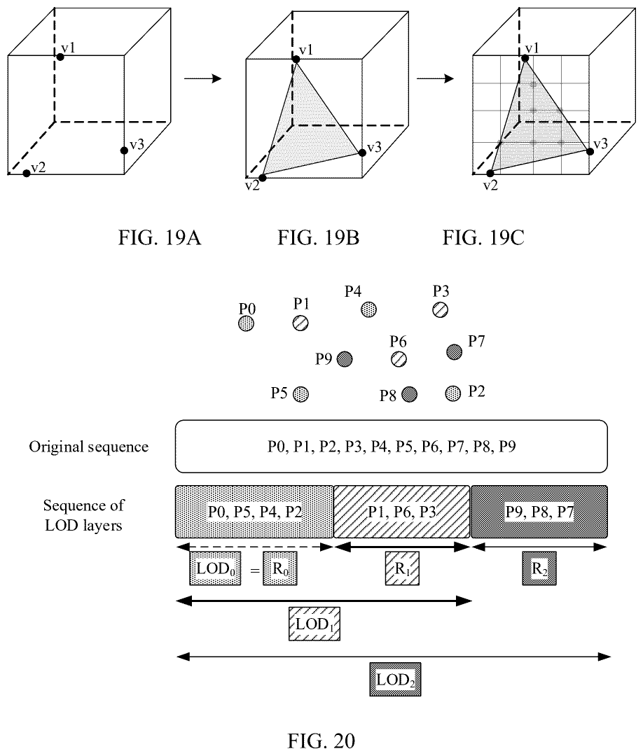

When reconstructing geometric information of a point cloud based on a trisoup, a decoding end first decodes vertex coordinates, to reconstruct a triangular patch. This process is shown in FIG. 19A, FIG. 19B, and FIG. 19C. There are three vertices (v1, v2, and v3) in the block shown in FIG. 19A. A triangle soup is formed by the three vertices in a specific order, that is, trisoup, as shown in FIG. 19B. Then, sampling is performed on the triangle soup, and obtained sampling points are used as a reconstructed point cloud in the block, as shown in FIG. 19C.

Predictive geometry coding (Predictive geometry coding, PredGeomTree) includes: sorting points of an input point cloud in sequence first, where sorting methods currently used include disordering, Morton ordering, azimuth ordering, and radial distance ordering. At an encoding end, a prediction tree structure is established in two different modes, including KD-tree (a high-latency slow mode) and a low-latency fast mode (by using LiDAR calibration information). When the LiDAR calibration information is used, points are assigned to different lasers, and a prediction tree structure is established according to the different lasers. Next, based on the prediction tree structure, each node in the prediction tree is traversed, geometric position information of the nodes is predicted by selecting different prediction modes, to obtain prediction residuals, and the geometric prediction residuals are quantized by using a quantization parameter. Finally, with continuous iterations, the prediction residuals of position information of the prediction tree nodes, the prediction tree structure, the quantization parameter, and the like are encoded to generate a binary bitstream.

For predictive geometry decoding, a decoding end continuously parses the bitstream to reconstruct a prediction tree structure, obtains prediction residual information of a geometric position of each prediction node and a quantization parameter through the parsing, and dequantizes the prediction residual to obtain reconstructed geometric position information of each node and finally complete geometric reconstruction.

After geometry encoding is completed, geometric information needs to be reconstructed. Currently, attribute encoding is mainly performed on color information. First, the color information is converted from an RGB color space to a YUV color space. Then, the point cloud is colored again by using the reconstructed geometric information, so that attribute information that is not encoded corresponds to the reconstructed geometric information. During encoding of the color information, there are mainly two transform methods. One method is distance-based enhanced transform based on LOD division, and the other method is to directly perform RAHT. In both methods, the color information is transformed from a spatial domain to a frequency domain, to obtain a high frequency coefficient and a low frequency coefficient. Finally, the coefficients are quantized and encoded to generate a binary bitstream. For details, reference may be made to FIG. 4A and FIG. 4B.

Further, when the attribute information is predicted by using the geometric information, a Morton code is used to perform nearest neighbor search. The Morton code corresponding to each point in the point cloud may be obtained by using geometric coordinates of the point. The following describes a specific method for calculating the Morton code. For three-dimensional coordinates in which each component is represented by a binary number with d bits, the three components may be represented as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ} \qquad ( 15 )$$

Herein, [symbol] ∈{0,1} are respectively binary values corresponding to a most significant bit ( [symbol] =1) to a least significant bit ( [symbol] =d) of x, y, and z. The Morton code M is obtained by arranging, for [symbol] x, y, and z in a sequence from the most significant bit to the least significant bit. A calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 16 )$$

Herein, m_{l′}∈{0,1} represents values from the most significant bit ( [symbol] =1) to the least significant bit ( [symbol] =3d) of M. After the Morton code M of each point in the point cloud is obtained, the points in the point cloud are arranged in ascending order of Morton codes, and a weight value w of each point is set to 1.

It may be further understood that, for a G-PCC encoding and decoding framework, common test conditions are as follows.

(1) there are four test conditions.
Condition 1: A geometric position is limited lossy and an attribute is lossy.
Condition 2: A geometric position is lossless and an attribute is lossy.
Condition 3: A geometric position is lossless and an attribute is limited lossy.
Condition 4: A geometric position is lossless and an attribute is lossless.

(2) A common test sequence includes four types: Cat1A, Cat1B, Cat3-fused, and Cat3-frame. A Cat2-frame point cloud includes only reflectance attribute information, a Cat1A or Cat1B point cloud includes only color attribute information, and a Cat3-fused point cloud includes both color attribute information and reflectance attribute information.

(3) There are two types of technologies, which are distinguished by algorithms used for geometric compression.

### Technology 1: Octree Geometry Encoding

At an encoding end, a bounding box is divided into sub-cubes, and sub-cubes (including points in a point cloud) that are not empty are further divided until leaf nodes obtained through the division are 1×1×1 unit cubes. In a case of lossless geometry encoding, a quantity of points included in each leaf node needs to be encoded, to finally complete octree geometry encoding and generate a binary bitstream.

At a decoding end, parsing is continuously performed in a breadth-first traversal sequence, to obtain an occupancy code of each node, and the nodes are sequentially divided until 1×1×1 unit cubes are obtained. In a case of lossless geometry decoding, parsing needs to be performed to obtain a quantity of points included in each leaf node, to finally restore reconstructed geometric information of a point cloud.

### Technology 2: Predictive Geometry Coding

At an encoding end, a prediction tree structure is established in two different modes: KD-tree (a high-latency slow mode) and LiDAR calibration information (a low-latency fast mode). By using the LiDAR calibration information, the points are assigned to different lasers, and a prediction tree structure is established according to the different lasers. Next, based on the prediction tree structure, each node in the prediction tree is traversed, geometric position information of the nodes is predicted by selecting different prediction modes, to obtain prediction residuals, and the geometric prediction residuals are quantized by using a quantization parameter. Finally, with continuous iterations, the prediction residuals of position information of the prediction tree nodes, the prediction tree structure, the quantization parameter, and the like are encoded to generate a binary bitstream.

At a decoding end, bitstreams are continuously parsed to reconstruct a prediction tree structure, prediction residual information of a geometric position of each prediction node and a quantization parameter are obtained through the parsing, and the prediction residual is dequantized to obtain reconstructed geometric position information of each node and finally complete geometric reconstruction.

It should be further noted that, as shown in FIG. 4A or FIG. 4B, currently, a G-PCC encoding framework includes three attribute encoding methods: predicting transform (Predicting Transform, PT), lifting transform (Lifting Transform, LT), and region adaptive hierarchical transform (Region Adaptive Hierarchical Transform, RAHT). In PT and LT, predictive encoding is performed on a point cloud based on a sequence of generating LODs, while in RAHT, adaptive transform is performed on attribute information based on a construction hierarchy of an octree from bottom to top. The following separately describes in detail the three methods for encoding a point cloud attribute.

### (a) Predictive Coding of Point Cloud Attribute Information

Currently, a G-PCC attribute prediction module uses a nearest neighbor attribute predictive coding scheme based on a level of detail (Level-of-details, LoDs) structure. An LOD construction method includes a distance-based LOD construction scheme, an LOD construction scheme based on a fixed sampling rate, an octree-based LOD construction scheme, and the like. In an LOD construction scheme based on a distance threshold, before an LOD structure is constructed, Morton sorting is performed on a point cloud to ensure relatively strong attribute correlation between neighboring points. FIG. 20 is a schematic diagram of a distance-based LOD construction process. As shown in FIG. 20, according to L Manhattan distances (dl) that are set in advance by a user, where l=0, 1, . . . , L−1, a point cloud is divided into L different levels of detail (Rl), where l=0, 1, . . . , L−1, and (dl)l=0, 1, . . . , L−1 meets dl<dl−1. The LOD construction process is as follows.

(1) First, all points in the point cloud are marked as not accessed, and a set V is established to store a set of points that have been accessed. (2) For each time of iteration I, the points in the point cloud are traversed. If a current point has been accessed, the point is ignored. Otherwise, a minimum distance D from the current point to the point set V is calculated. If D<dl, the point is ignored. Otherwise, the current point is marked as accessed and added to a refinement layer Rl and the point set V. (3) Points in a level of detail LOD/include points in refinement layers R0, R1, R2, . . . , and Rl. (4) The foregoing steps are repeated until all the points are marked as accessed.

Based on an LOD structure, linear weighted prediction is performed on an attribute value of each point by using a reconstructed attribute value of a point in a same or higher LOD layer, where a maximum quantity of reference prediction neighbors is determined by a higher-level syntax element of an encoder. For an attribute of each point, at an encoding end, a rate-distortion optimal algorithm is used to select attributes of N found nearest neighboring points, to perform weighted prediction, or to select an attribute of a single nearest neighboring point for prediction. Finally, a selected prediction mode and a prediction residual are encoded.

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} {Attr}_{m} \qquad ( 17 )$$

Herein, N represents a quantity of predicted points in a set of nearest neighboring points of a point i, Pi represents a sum of N nearest neighboring points of the point i, Dm represents a spatial geometric distance from the nearest neighboring point m to the current point i, Attrₘ represents a reconstructed attribute value of the nearest neighboring point m, Attrᵢ′ represents a predicted attribute value of the current point i, and the quantity N of the points is a preset value.

To balance attribute encoding efficiency with parallel processing between different LOD layers, a switch is introduced into the higher-level syntax element of the encoder, to control whether to introduce intra-LOD prediction. If the switch is turned on, intra-LOD prediction is enabled, and points in a same LOD layer can be used for prediction. It should be noted that intra-LOD prediction is always used when a quantity of LOD layers is 1.

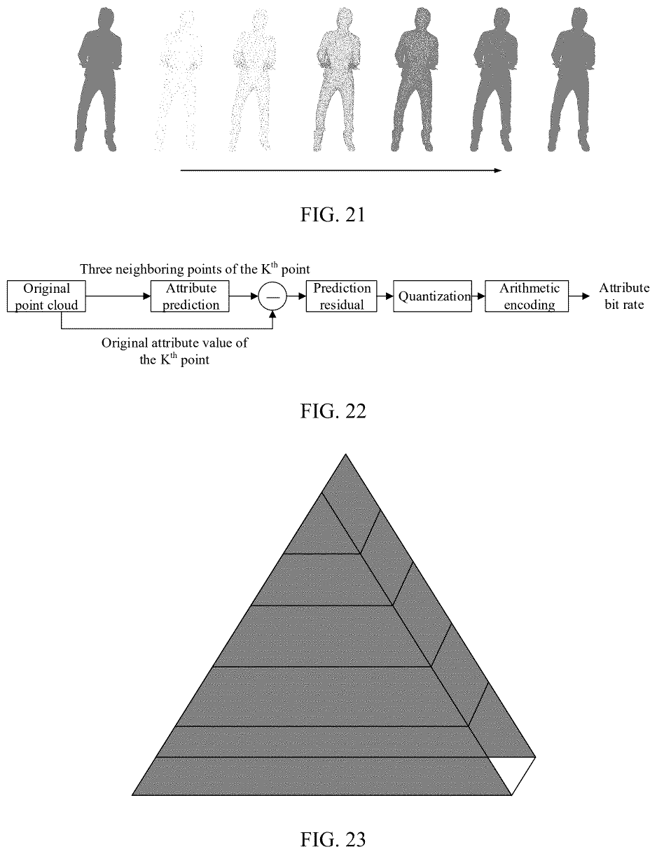

FIG. 21 is a schematic diagram of a visualized result of an LOD generation process. As shown in FIG. 21, a visualized example of a distance-based LOD generation process is provided. Specifically (from left to right), points in the first layer represent an outer contour of a point cloud. As a quantity of levels of detail increases, detailed descriptions of the point cloud gradually become clear.

FIG. 22 is a schematic flowchart of attribute predictive coding. FIG. 22 shows a specific procedure of G-PCC attribute prediction. For an original point cloud, first, three neighboring points of the K^{th} point are searched, and then attribute prediction is performed. Then, a difference between a predicted attribute value of the K^{th} point and an original attribute value of the K^{th} point is calculated, to obtain a prediction residual of the K^{th} point. Then, quantization and arithmetic coding are performed on the prediction residual, to finally generate an attribute bit rate.

### (i) Selection of an Optimal Predicted Value:

After LOD construction is completed, first, three nearest neighboring points of a current to-be-encoded point are found from encoded data points according to a sequence of generating LODs. Reconstructed attribute values of the three nearest neighboring points are used as candidate predicted values of the current to-be-encoded point. Then, an optimal predicted value is selected from the candidate predicted values according to rate-distortion optimal (Rate-Distortion Optimal, RDO). For example, when an attribute value of a point P2 in FIG. 20 is encoded, a prediction variable index of an attribute value of the nearest neighboring point P4 is set to 1, prediction variable indexes of attribute values of the second nearest neighboring point P5 and the third nearest neighboring point P0 are set to 2 and 3, respectively, and prediction variable indexes of weighted average values of the points P0, P5, and P4 are set to 0, as shown in Table 1. Finally, an optimal prediction variable is selected by using RDO. A formula for the weighted averaging is as follows:

$${\hat{a}}_{i} = Round ( {\sum }_{j = 0}^{2} \frac{{\tilde{w}}_{ij}}{{\sum }_{j = 0}^{2} {\tilde{w}}_{ij}} {\tilde{a}}_{j} ) \qquad ( 18 )$$

Herein, \tilde{w}ᵢⱼ represents a spatial geometric weight from a neighboring point j to a current point i.

$$\text{?} \qquad ( 19 )$$

$$\text{?} \text{indicates text missing or illegible when filed}$$

Herein, \hat{α}ᵢ represents a predicted attribute value of the current point i, j represents indexes of the three neighboring points, ãⱼ represents a reconstructed attribute value of a neighboring point, xᵢ, yᵢ, zᵢ are geometric position coordinates of the current point i, and xᵢⱼ, yᵢⱼ, zᵢⱼ are geometric coordinates of the neighboring point j.

Exemplarily, Table 1 provides an example of candidate prediction samples for attribute encoding.

TABLE 1

| Prediction | |
|---|---|
| mode | Predicted value |
| 0 | Weighted averaging of attributes of the three nearest |
| | neighbors |
| 1 | P4 (attribute value of the nearest neighbor) |
| 2 | P5 (attribute value of the second nearest neighbor) |
| 3 | P0 (attribute value of the third nearest neighbor) |

### (ii) Attribute Prediction Residual and Quantization:

The predicted attribute value (\hat{α}ᵢ)_{i∈0_k-1} of the current point i is obtained through the foregoing prediction (k is a total quantity of points in a point cloud). If (αᵢ)_{i∈0_k-1} is an original attribute value of the current point, the attribute residual (rᵢ)_{i∈0_k-1} is denoted as:

$${r}_{i} = {a}_{i} - {\hat{a}}_{i} \qquad ( 20 )$$

Further, the prediction residual is quantized:

$${Q}_{i} = \frac{{r}_{i}}{Qs} \qquad ( 21 )$$

Herein, Qᵢ represents the quantized attribute residual of the current point i, QS is a quantization step (Quantization step, QS), which may be calculated by using a quantization parameter QP (Quantization Parameter, QP) specified by CTC.

(iii) Attribute value reconstruction at an encoding end:

At the encoding end, an attribute value is reconstructed to predict a subsequent point. Before the attribute value is reconstructed, a residual is dequantized, and r is denoted as the dequantized residual.

$${\hat{r}}_{j} = {Q}_{i} \times Q s \qquad ( 22 )$$

\hat{r}ᵢ and the predicted value \hat{α}ᵢ are added to obtain the reconstructed value at of the point i:

$${\tilde{a}}_{i} = {\hat{r}}_{t} + {\hat{a}}_{i} \qquad ( 23 )$$

When attribute nearest neighbor search is performed based on LOD division, currently, there are two types of algorithms: intra-frame nearest neighbor search and inter-frame nearest neighbor search. An inter-frame nearest neighbor search algorithm is specifically as follows. Intra-frame nearest neighbor search may be divided into two algorithms: inter-layer nearest neighbor search and intra-layer nearest neighbor search.

### (i) Intra-Frame Nearest Neighbor Search:

Intra-frame nearest neighbor search is divided into two algorithms: inter-layer nearest neighbor search and intra-layer nearest neighbor search. After LOD division, a structure similar to a pyramid is obtained, as shown in FIG. 23.

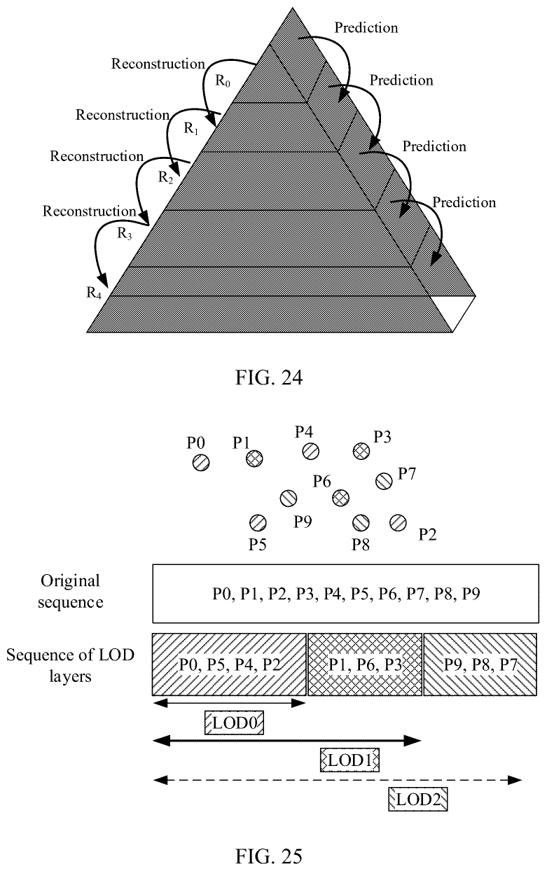

In a specific implementation, for inter-layer nearest neighbor search, a pyramid structure is shown in FIG. 24. FIG. 25 is a schematic diagram of an LOD construction process for inter-layer nearest neighbor search. As shown in FIG. 25, different LOD layers, that is, an LOD 0, an LOD 1, and an LOD 2, are obtained through division based on geometric information. Then, a point in the LOD 0 is used to predict an attribute of a point in a next LOD layer during inter-layer nearest neighbor search.

The following describes in detail an entire process of intra-frame nearest neighbor search.

In an entire LOD division process, there are three sets, that is, O(k), L(k), and I(k), where k is an index of an LOD layer during LOD division, I(k) is an input point set during division of a current LOD layer, sets O(k) and L(k) are obtained after LOD division, the set O(k) stores a set of sampling points, and L(k) is a set of points in the current LOD layer. That is, the entire LOD division process is as follows:
(1) Initialization

$$if k = 0 , L ( k ) ← \{ \} . Otherwise , L ( k ) ← L ( k - 1 )$$

$$O ( k ) ← \{ \}$$

(2) By using an LOD division algorithm, the sampling points are stored in O(k), and the remaining points are allocated to L(k).
(3) When a next time of iteration is performed, l←O(k).

It should be noted herein that because the entire LOD division process is performed based on a Morton code, O(k), L(k), and I(k) store Morton code indexes corresponding to points.

When inter-layer nearest neighbor search is performed, that is, nearest neighbor search is performed on the set O(k) for the points in the set L(k), a specific search algorithm is as follows:

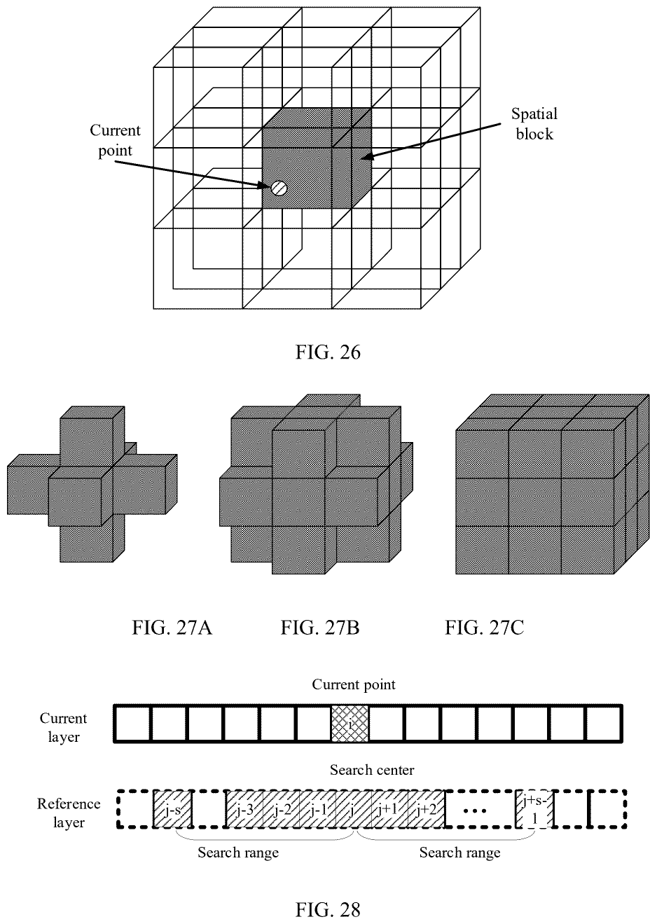

Nearest neighbor search is performed based on a spatial relationship. When a current point P is predicted, neighbor search is performed by using a parent block (Block B) corresponding to the point P, as shown in FIG. 26, to search for points that are in neighboring blocks and that share a face or an edge with the current parent block. These points are used for attribute prediction.

FIG. 27A is a schematic diagram of a coplanar spatial relationship, where six spatial blocks have a relationship with a current parent block. FIG. 27B is a schematic diagram of coplanar and co-edge spatial relationships, where 18 spatial blocks have a relationship with a current parent block. FIG. 27C is a schematic diagram of coplanar, co-edge, and co-vertex spatial relationships, where 26 spatial blocks have a relationship with a current parent block.

First, a corresponding spatial block is obtained by using coordinates of the current point, and then nearest neighbor search is performed in a previously encoded LOD layer, to search for a spatial block that shares a face, an edge, or a vertex with the current block, thereby obtaining N neighbors of the current point.

If the N neighbors of the current point are still not obtained after searching coplanar, co-edge, or co-vertex nearest neighbors, the N neighbors of the current point are obtained based on a fast search algorithm. A specific algorithm is as follows.

As shown in FIG. 28, when inter-layer attribute prediction is performed, first, geometric coordinates of a current to-be-encoded point are used to obtain a Morton code corresponding to the current point. Then, a reference frame is searched, based on the Morton code of the current point, for the first reference point (j) whose Morton code is greater than the Morton code of the current point. Then, nearest neighbor search is performed within a range [j−searchRange, j+searchRange].

The remining specific algorithm for updating the nearest neighbor is consistent with an inter-frame nearest neighbor search algorithm, and therefore is not described in detail herein. A specific algorithm is mentioned in the inter-frame nearest neighbor search algorithm.

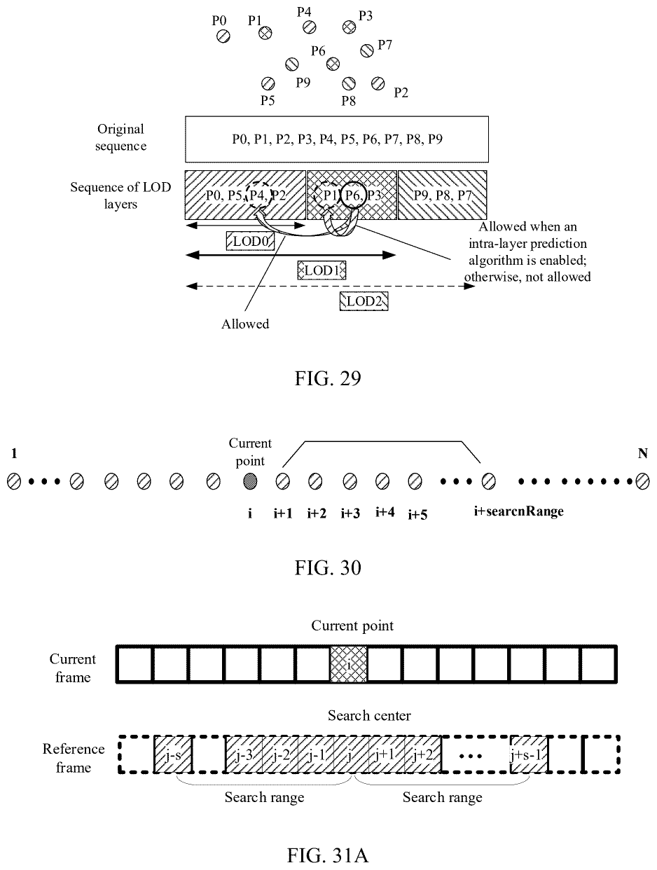

In another specific implementation, for intra-layer nearest neighbor search, FIG. 29 is a schematic structural diagram of an LOD structure for intra-layer attribute nearest neighbor search. As shown in FIG. 29, if an intra-layer prediction algorithm is enabled, that is, a syntax element EnableRefferingSameLoD=1, intra-layer nearest neighbor search may be allowed. For example, for an LOD 1, the nearest neighboring point of a current point P6 may be P1, and nearest neighbor search is not allowed to be performed in another layer. If the syntax element EnableRefferingSameLoD=0, nearest neighbor search is allowed to be performed in other layers. For example, for the LOD 1, the nearest neighboring point of the current point P6 may be P4. That is, when an intra-layer prediction algorithm is enabled, nearest neighbor search is performed in a set of encoded points in a same LOD layer, to obtain N neighbors of a current point (inter-layer nearest neighbor search is performed similarly).

In performing intra-layer attribute prediction, nearest neighbor search is performed based on a fast search algorithm. A specific algorithm is shown in FIG. 30. A current point is represented by using a grid. Assuming that an index of a Morton code of the current point is i, nearest neighbor search is performed within [i+1, i+searchRange]. A specific nearest neighbor search algorithm is consistent with an inter-frame fast search algorithm based on blocks, and details are not described herein again.

(ii) Inter-frame nearest neighbor search:

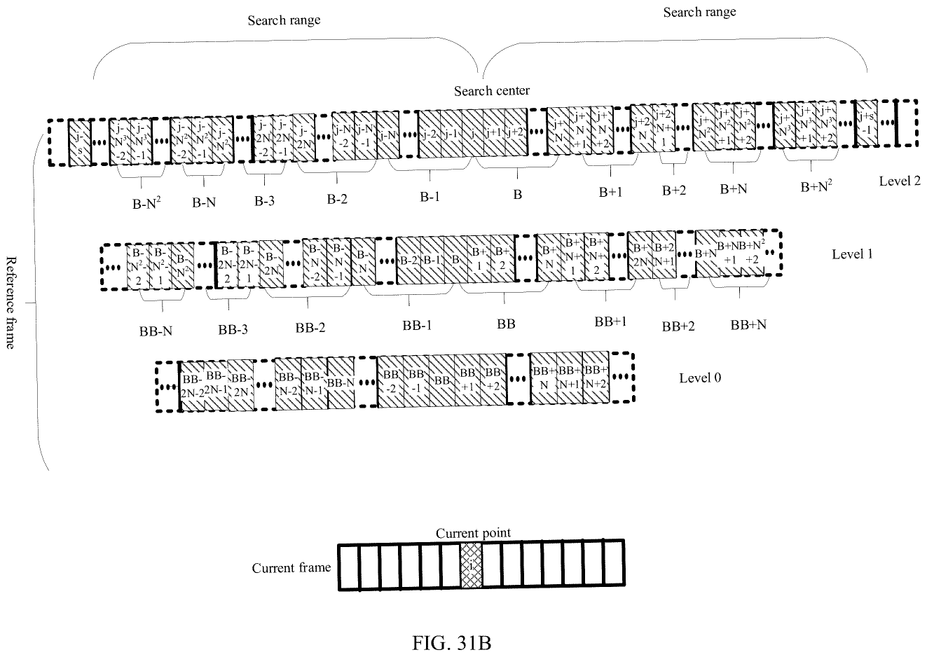

FIG. 31A is a schematic diagram of attribute inter prediction based on fast search. As shown in FIG. 31A, in performing attribute inter prediction, first, geometric coordinates of a current to-be-encoded point are used to obtain a Morton code corresponding to the current point. Then, a reference frame is searched, based on the Morton code of the current point, for the first reference point (j) whose Morton code is greater than the Morton code of the current point. Then, nearest neighbor search is performed within a range [j−searchRange, j+searchRange].

Currently, intra-frame nearest neighbor search and inter-frame nearest neighbor search are performed based on blocks. For details, reference may be made to FIG. 31B. As shown in FIG. 31B, when neighbor search is performed on a current point (with a Morton code index of i), first, points in a reference frame are divided into N (N=3) layers according to Morton codes. A specific division algorithm is as follows.
First layer: Assuming that a quantity of the points in the reference frame is numPoints, first, every M (M=2⁵=32) points in the reference frame are allocated to one block.
Second layer: On a basis of the first layer, every M (M=2⁵=32) blocks of the first layer are allocated to one block according to a sequence of Morton codes.
Third layer: On a basis of the second layer, every M (M=2⁵=32) blocks of the second layer are allocated to one block according to the sequence of the Morton codes.
Finally, a prediction structure shown in FIG. 31B is obtained.

Attribute prediction is performed based on the prediction structure shown in FIG. 31B. Assuming that the index of the Morton code of the current to-be-encoded point is i, first, the first point whose Morton code is greater than or equal to the Morton code of the current point is obtained in the reference frame, where an index of this point is j. Then, a block index of the reference point is calculated based on j. A specific calculation manner is as follows.

$$First layer : BucketSize\_ 0 = {2}^{5} = 32 ;$$

$$Second layer : BucketSize\_ 1 = {2}^{5} = 32 \times BucketSize\_ 0 = 1024 ;$$

$$Third layer : BucketSize\_ 2 = {2}^{5} = 32 \times BucketSize\_ 1 = 32768.$$

Assuming that a reference range in a prediction frame of the current point is [j−searchRange, j+searchRange], a start index of the third layer is calculated by using j-searchRange, and an end index of the third layer is calculated by using j+searchRange. Then, first, it is determined, in blocks of the third layer, whether nearest neighbor search needs to be performed on some blocks of the second layer. Then, for the second layer, it is determined whether nearest neighbor search needs to be performed on each block of the first layer. If nearest neighbor search needs to be performed on some blocks of the first layer, point-by-point determining is performed on points in the blocks of the first layer, to update nearest neighbors.

The following describes the algorithm of calculating the blocks based on the indexes. Assuming that the index of the Morton code corresponding to the current point is denoted as index, an index of a corresponding block in the third layer is calculated as follows:

$$idx\_ 2 = index / BucketSize\_ 2 \qquad ( 24 )$$

After the index idx_2 of the block in the third layer is obtained, a start index and an end index of blocks corresponding to the current block in the second layer may be obtained by using idx_2:

$$startIdx 1 = idx\_ 2 \times BucketSize\_ 1 \qquad ( 25 )$$

$$endIdx = idx\_ 2 \times BucketSize\_ 1 + B u c ketSize\_ 1 - 1 \qquad ( 26 )$$

Similarly, indexes of blocks in the first layer are obtained based on the indexes of the blocks in the second layer by using the same algorithm.

In performing nearest neighbor search based on blocks, first, it is determined whether nearest neighbor search needs to be performed on the current block, that is, screening out blocks for nearest neighbor search. Each spatial block may be obtained by using two variables minPos and maxPos, where minPos represents a minimum value of the block, and maxPos represents a maximum value of the block.

It is assumed that a distance to the farthest point in N found neighbors of the current point is Dist, coordinates of the to-be-encoded point are (x, y, z), and the current block is represented as (minPos, maxPos), where minPos is a minimum value in the three dimensions of the bounding box, and maxPos is a maximum value in the three dimensions of the bounding box. In this case, a distance D between the current point and the bounding box is calculated as follows:

$$int dx = int ( std ∷ max ( std ∷ max ( min Pos [ 0 ] - point [ 0 ] , 0 ) , point [ 0 ] - max Pos [ 0 ] ) ) ;$$

$$int dy = int ( std ∷ max ( std ∷ max ( min Pos [ 1 ] - point [ 1 ] , 0 ) , point [ 1 ] - max Pos [ 1 ] ) ) ;$$

$$int dx = int ( std ∷ max ( std ∷ max ( min Pos [ 2 ] - point [ 2 ] , 0 ) , point [ 2 ] - max Pos [ 2 ] ) ) ;$$

$$D = dx + dy + dz$$

When D is less than or equal to Dist, the points in the current block are traversed.

### (b) Lifting Transform Coding of Point Cloud Attribute Information

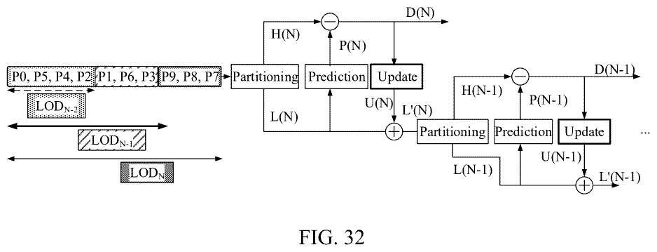

FIG. 32 is a schematic flowchart of lifting transform coding. The lifting transform is also used to perform predictive encoding on an attribute of a point cloud based on LODs. Different from predictive transform, lifting transform first divides LODs into high and low layers, performs prediction in a reverse sequence of generating LOD layers, and updates quantization weights of points in low LOD layers by introducing an update operator in a prediction process, to improve prediction accuracy. This is because an attribute value of a point in a low LOD layer is frequently used for prediction of an attribute value of a point in a high LOD layer, and the point in the low LOD layer should have greater influence.

### Step 1: Partitioning Process.

In the partitioning process, the overall LOD layers are divided into a low LOD layer L(N) and a high LOD layer H(N). If a point cloud has three LOD layers, that is, (LOD₁) . . . after the division, LOD₂ is the high LOD layer and is denoted as H(N), and (LOD₁), are the low LOD layer and are denoted as L(N).

### Step 2: Prediction Process.

For a point in the high LOD layer, attribute information of the nearest neighboring point selected from the low layer is used as an attribute prediction value P(N) of a current to-be-encoded point, and a prediction residual D(N) is denoted as:

$$D ( N ) = H ( N ) - P ( N ) \qquad ( 27 )$$

### Step 3: Update Process.

An attribute prediction residual D(N) in the high LOD layer is updated, to obtain U(N), and U(N) is used to lifting an attribute value of a point in the low LOD layer, as shown in the following formula:

$${L}^{′} ( N ) = L ( N ) + U ( N ) \qquad ( 28 )$$

The foregoing processes are continuously iterated in descending order of LODs until the lowest LOD layer is processed.

In the LOD-based prediction solution, a point in a low LOD layer has greater influence. Therefore, in a lifting wavelet transform solution, a quantization weight is introduced, and a prediction residual D(N) is updated by according to the prediction residual and a distance between a prediction point and a neighboring point. Finally, adaptive quantization is performed on the prediction residual by using the quantization weight in the transform process. It should be noted that, at a decoding end, a quantization weight value of each point may be determined through geometric reconstruction, and therefore, the quantization weight does not need to be encoded.

### (c) Region Adaptive Hierarchal Transform

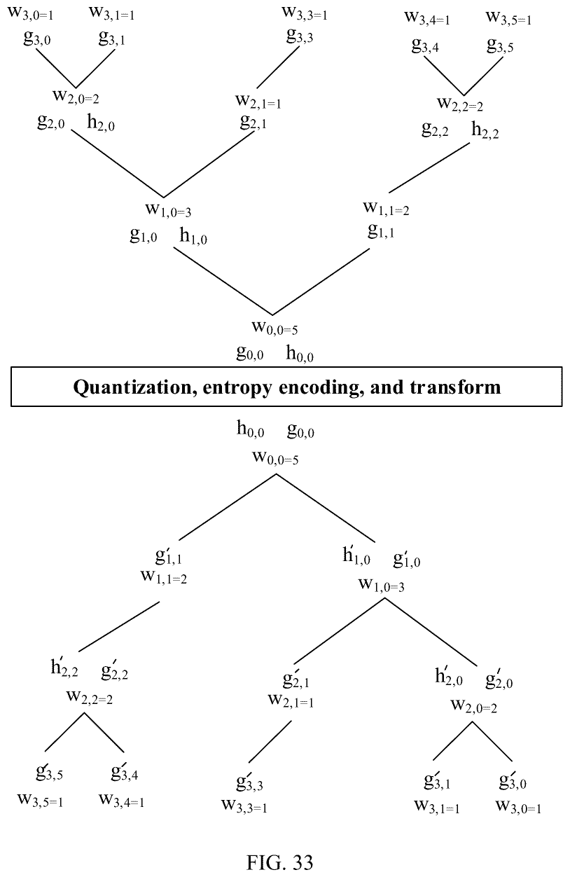

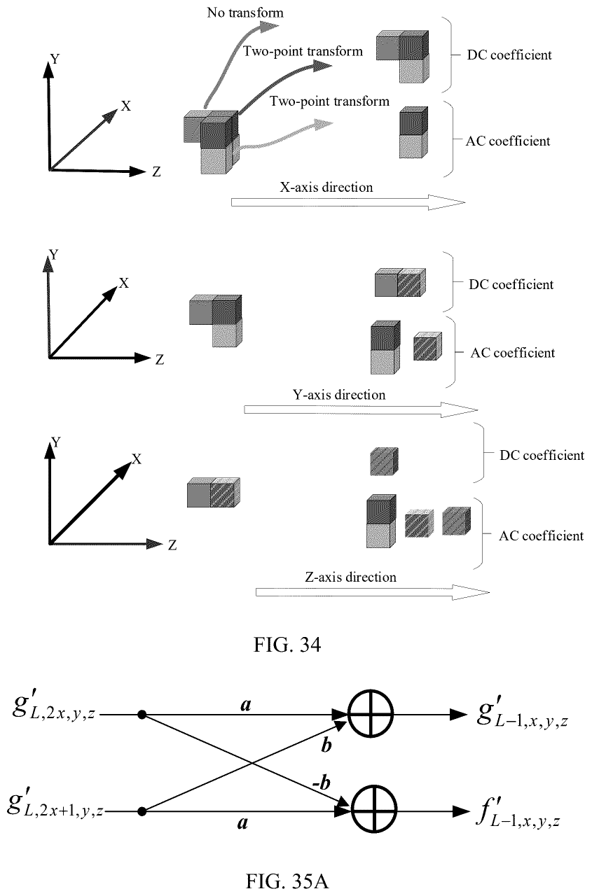

Region adaptive hierarchal transform (RAHT) is a type of Haar wavelet transform, which may transform attribute information of a point cloud from a spatial domain to a frequency domain, thereby further reducing correlation between attributes of the point cloud. The main idea is to transform, in three dimensions X, Y, and Z, nodes in each layer from bottom to top according to an octree structure (as shown in FIG. 34), iterating until a root node of the octree is processed. As shown in FIG. 33, a basic idea of the RAHT is that wavelet transform is performed based on a hierarchical structure of the octree. Attribute information is associated with nodes of the octree, recursive transform is performed from bottom to top on attributes of occupied nodes in a same parent node, and nodes in each layer are transformed in three dimensions X, Y, and Z until a root node of the octree is processed. In a hierarchical transform process, low-pass/low-frequency (DC) coefficients obtained by performing transform on nodes in a same layer are transferred to nodes in a next layer for further transform, and all high-pass/high-frequency (AC) coefficients are encoded by using an arithmetic encoder.

During the transform, the DC coefficients (direct current components) obtained by performing transform on the nodes in the same layer are transferred to an upper layer for further transform, and quantization encoding is performed on AC coefficients (alternating current components) obtained in each layer by the transform. The following describes main transform processes.

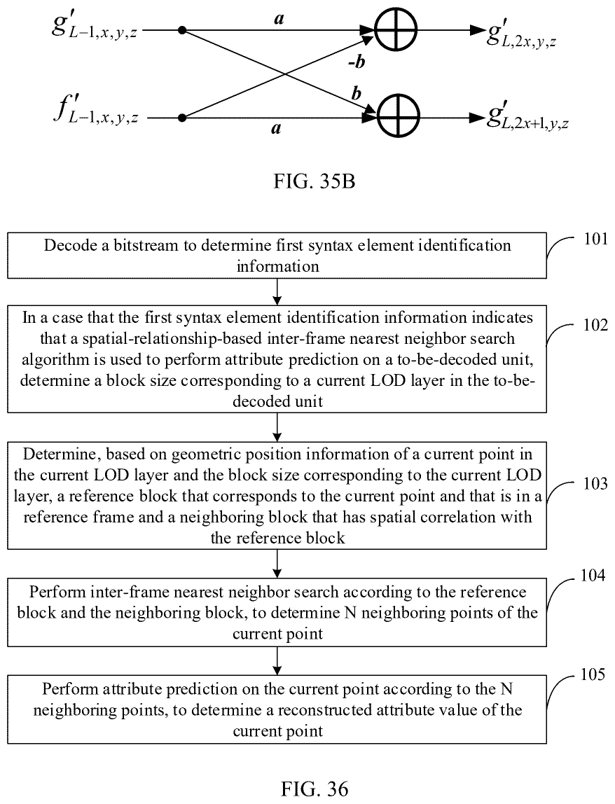

FIG. 35A is a schematic diagram of a forward RAHT process, and FIG. 35B is a schematic diagram of an inverse RAHT process. For a forward RAHT process and an inverse RAHT process, it is assumed that g and g are two attribute DC coefficients of two neighboring points in a layer L. After linear transform is performed, information about a layer L-1 is an AC coefficient and a DC coefficient g. Then, transform is no longer performed on, and quantization encoding is directly performed on Nearest neighbor search is performed for transforming g. If no neighbor is found, g is directly transferred to a layer L-2. That is, RAHT is only valid for a node that has a neighboring point, and a node without a neighboring point is directly transferred to an upper layer. In the foregoing transform process, weights (quantities of non-empty subnodes in the node) corresponding to g and g are respectively and (and w₁′ for short), a weight of g is, and a general transform formula is as follows:

$$\text{?} = g \qquad ( 29 )$$

$$\text{?} \text{indicates text missing or illegible when filed}$$

Herein is a transform matrix which is calculated as follows:

$$\text{?} \sqrt{{w}_{1}^{′}} = \qquad ( 30 )$$

$$\text{?} \text{indicates text missing or illegible when filed}$$

The transform matrix is adaptively updated with a weight corresponding to each point. The foregoing process is iteratively updated according to a partitioning structure of an octree until a root node of the octree is processed.

Based on this, embodiments of this application provide an encoding method and a decoding method. First syntax element identification information is used to indicate whether to use a spatial-relationship-based inter-frame nearest neighbor search algorithm to perform attribute prediction on a to-be-decoded unit. Inter-frame nearest neighbor search is performed on an attribute of a point cloud based on spatial correlation between point cloud attributes, and attribute prediction is performed by using N found neighboring points, so that correlation between point cloud attributes of neighboring frames can be further removed, and encoding and decoding efficiency of point cloud attributes can be improved, thereby improving encoding and decoding performance of the point cloud.

To facilitate understanding of the technical solutions in embodiments of this application, the following describes the technical solutions in this application in detail by using specific embodiments. The foregoing related technologies, as optional solutions, may be randomly combined with the technical solutions of embodiments of this application, all of which fall within the protection scope of embodiments of this application. Embodiments of this application include at least a part of the following content. This application provides an encoding method and a decoding method, and more specifically, provides a point cloud encoding and decoding technology.

The following describes embodiments of this application in detail with reference to the accompanying drawings.

In an embodiment of this application, referring to FIG. 36, FIG. 36 is a schematic flowchart of a decoding method according to this embodiment of this application. As shown in FIG. 36, the method may include the following steps.

Step 101: Decode a bitstream to determine first syntax element identification information.

It should be noted that, in embodiments of this application, the decoding method is applied to a point cloud decoder (which may be referred to as a “decoder” for short). The decoding method may be specifically a point cloud attribute decoding method. More specifically, a spatial-relationship-based inter-frame nearest neighbor search algorithm is used to perform attribute prediction on a point cloud attribute, in which N neighboring points are determined, and the attribute is predicted by using reconstructed attribute values of the N neighboring points.

It should be further noted that, in embodiments of this application, a spatial-relationship-based inter-frame nearest neighbor search algorithm is introduced to perform attribute prediction, and correlation between geometric spatial distribution of point clouds is considered, thereby improving attribute encoding efficiency of a point cloud. Specifically, a switch may be introduced into a higher-level syntax element, to control whether to use a spatial-relationship-based inter-frame nearest neighbor search algorithm to perform attribute prediction on a to-be-decoded unit. That is, the first syntax element identification information is used to indicate whether to use a spatial-relationship-based inter-frame nearest neighbor search algorithm to perform attribute prediction on the to-be-decoded unit.

In some embodiments, the method further includes: when the first syntax element identification information is a first value, determining that the spatial-relationship-based inter-frame nearest neighbor search algorithm is used to perform attribute prediction on the to-be-decoded unit; or when the first syntax element identification information is a second value, determining that the spatial-relationship-based inter-frame nearest neighbor search algorithm is not used to perform attribute prediction on the to-be-decoded unit.

It should be noted that in embodiments of this application, the first syntax identification information may be represented by lod_dist_log 2_offset_inter present. The first value may be in a parameter form, or may be in a numeric form. For example, the first value may be set to 1, and the second value may be set to 0.

In some embodiments, the to-be-decoded unit may be a to-be-decoded slice. Exemplarily, a current frame may be divided into a plurality of pieces, for example, Slice_0, Slice_1, Slice_2, and Slice_3. For each slice, the first syntax element identification information may be used to indicate whether to use the spatial-relationship-based inter-frame nearest neighbor search algorithm to perform attribute prediction.

In some embodiments, the first syntax element identification information includes at least one of the following: a sequence-level syntax element, a frame-level syntax element, or a slice-level syntax element. It should be noted that, a sequence-level syntax element is used to indicate whether to use the spatial-relationship-based inter-frame nearest neighbor search algorithm to perform attribute prediction on a current sequence; a frame-level syntax element is used to indicate whether to use the spatial-relationship-based inter-frame nearest neighbor search algorithm to perform attribute prediction on a current frame; and a slice-level syntax element is used to indicate whether to use the spatial-relationship-based inter-frame nearest neighbor search algorithm to perform attribute prediction on a current slice.

Exemplarily, the first syntax element identification information includes a sequence-level syntax element, a frame-level syntax element, and a slice-level syntax element. Exemplarily, the first syntax element identification information includes a sequence-level syntax element. Exemplarily, the first syntax element identification information includes a frame-level syntax element.

In some embodiments, the decoding the bitstream to determine the first syntax element identification information includes: decoding the bitstream to determine an attribute data unit header syntax; and determining the first syntax element identification information from the attribute data unit header syntax.

In some embodiments, the to-be-decoded unit may be another image unit, for example, a coding tree unit (Coding Tree Unit, CTU) or a coding unit (Coding Unit, CU).

Step 102: In a case that the first syntax element identification information indicates that a spatial-relationship-based inter-frame nearest neighbor search algorithm is used to perform attribute prediction on the to-be-decoded unit, determine a block size corresponding to a current LOD layer in the to-be-decoded unit.

It should be noted that, the using the spatial-relationship-based inter-frame nearest neighbor search algorithm to perform attribute prediction includes: performing block division on a point cloud of a reference frame according to a block size when performing inter-frame nearest neighbor search on an attribute, and performing nearest neighbor search by using spatial correlation between blocks, to determine N neighboring points. In embodiments of this application, attribute nearest neighbor search is performed based on LOD division. Because a distance between points in each LOD layer is different, a block size corresponding to each LOD layer needs to be determined. Then, block division is performed on a point cloud of a reference frame according to the block size corresponding to the LOD layer, to improve efficiency of nearest neighbor search.

It should be noted that if a square block is used to perform block division on the point cloud of the reference frame, a corresponding block size may be a side length of the square block. In some other embodiments, a rectangular block is used to perform block division on the point cloud of the reference frame, and a corresponding block size may be a length, a width, and a height of the rectangular block.

In some embodiments, the determining the block size corresponding to the current LOD layer in the to-be-decoded unit includes: decoding the bitstream to determine second syntax element identification information; and determining, based on the second syntax element identification information, the block size corresponding to the current LOD layer in the to-be-decoded unit.

It should be noted that the second syntax element identification information is used to indicate a block size corresponding to an initial LOD layer in the to-be-decoded unit. The determining, based on the second syntax element identification information, the block size corresponding to the current LOD layer in the to-be-decoded unit includes: determining, based on the second syntax element identification information, the block size corresponding to the initial LOD layer in the to-be-decoded unit; and determining, based on the block size corresponding to the initial LOD layer, the block size corresponding to the current LOD layer in the to-be-decoded unit. That is, the block size corresponding to the initial LOD layer in the to-be-decoded unit is indicated by the second syntax element identification information, and a block size corresponding to another layer is derived according to the block size corresponding to the initial LOD layer.

Exemplarily, the determining, based on the second syntax element identification information, the block size corresponding to the initial LOD layer in the to-be-decoded unit includes: determining, based on the second syntax element identification information, a reference value of the block size corresponding to the initial LOD layer; and determining, based on the reference value of the block size, the block size corresponding to the initial LOD layer. Specifically, preset mathematical derivation is performed according to the reference value of the block size, to determine the block size. That is, the block size may be directly indicated by a second syntax element, or may be indirectly indicated by indicating the reference value of the block size.

Exemplarily, the determining, based on the block size corresponding to the initial LOD layer, the block size corresponding to the current LOD layer in the to-be-decoded unit includes: when the current LOD layer is not the initial LOD layer, determining a block size corresponding to the (i−1)^{th} LOD layer based on a block size corresponding to the i^{th} LOD layer and a preset scaling parameter, where the block size corresponding to the initial LOD layer is an initial parameter of the block size corresponding to the i^{th} LOD layer.

As shown in FIG. 21 and FIG. 23, according to a sequence of generating LODs, the initial LOD layer may be the last generated LOD layer, and points in the initial LOD layer are most densely distributed. From the last generated LOD layer to the first generated LOD layer, point density decreases. Therefore, after the block size corresponding to the initial LOD layer is determined, block sizes corresponding to other LOD layers are successively determined based on the block size corresponding to the initial LOD layer and the preset scaling parameter. Exemplarily, a scaling parameter between two neighboring layers may be set to 2.

In some embodiments, respective second syntax element identification information is set for each LOD layer, that is, the second syntax element identification information is used to indicate the block size corresponding to a respective LOD layer.

In some embodiments, the decoding the bitstream to determine the second syntax element identification information includes: decoding the bitstream to determine an attribute data unit header syntax; and determining the second syntax element identification information from the attribute data unit header syntax.

In some embodiments, the determining the block size corresponding to the current LOD layer in the to-be-decoded unit includes: determining the block size corresponding to the initial LOD layer in the to-be-decoded unit as a preset block size.

Step 103: Determine, based on geometric position information of a current point in the current LOD layer and the block size corresponding to the current LOD layer, a reference block that corresponds to the current point and that is in a reference frame and a neighboring block that has spatial correlation with the reference block.

In some embodiments, the spatial correlation includes at least one of the following: coplanar, co-edge, or co-vertex. FIG. 27A is a schematic diagram of a coplanar spatial relationship, FIG. 27B is a schematic diagram of coplanar and co-edge spatial relationships, and FIG. 27C is a schematic diagram of coplanar, co-edge, and co-vertex spatial relationships.

In some embodiments, the determining, based on the geometric position information of the current point in the current LOD layer and the block size corresponding to the current LOD layer, the reference block that corresponds to the current point and that is in the reference frame and the neighboring block that has spatial correlation with the reference block includes: determining, based on the geometric position information of the current point in the current LOD layer and the block size corresponding to the current LOD layer, geometric position information of the reference block that corresponds to the current point and that is in the reference frame; and determining, based on the geometric position information of the reference block and the block size corresponding to the current LOD layer, the neighboring block that has spatial correlation with the reference block.

Exemplarily, geometric position information of a reference point that corresponds to the current point and that is in the reference frame is determined based on the geometric position information of the current point; the geometric position information of the reference block in which the reference point is located is determined based on the geometric position information of the reference point and the block size corresponding to the current LOD layer; and position information of the neighboring block that has spatial correlation with the reference block is determined based on the geometric position information of the reference block and the block size corresponding to the current LOD layer. More specifically, a Morton code of the current point is determined based on the geometric position information of the current point; the reference frame is searched, according to the Morton code of the current point, for the first reference point whose Morton code is greater than the Morton code of the current point; and geometric position information of the reference point is determined based on the Morton code of the reference point.

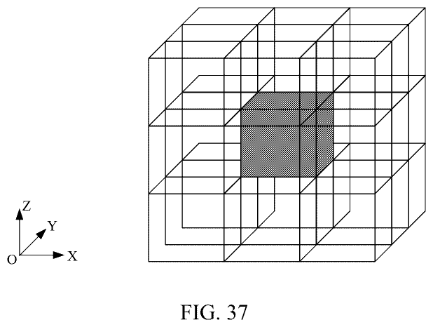

FIG. 37 is a schematic spatial relationship diagram of inter-frame nearest neighbor search based on a spatial relationship. As shown in FIG. 37, when inter-frame nearest neighbor search is performed on a current point, a reference block that corresponds to the current point and that is in a reference frame is a cube central block. First, the reference frame is searched for a neighboring block that shares a face, an edge, or a vertex with the reference block corresponding to the current point, and then nearest neighbor search is performed by using points in the found nearest neighboring block, to determine N inter-frame neighboring points for attribute prediction, thereby improving attribute encoding and decoding efficiency of a point cloud.

Step 104: Perform inter-frame nearest neighbor search according to the reference block and the neighboring block, to determine N neighboring points of the current point.

In some embodiments, the method further includes: determining that a quantity of neighboring points of the current point obtained by performing the inter-frame nearest neighbor search according to the reference block and the neighboring block is less than N; and performing nearest neighbor search in the reference frame by using a fast search algorithm, to determine the N neighboring points of the current point.

It should be noted that, in embodiments of this application, the reference frame is searched, by using a spatial relationship of the current point, for a neighboring block that shares a face, an edge, or a vertex with a parent block corresponding to the current point, nearest neighbor search is performed on the found neighboring block, and inter prediction is performed on an attribute of the current point according to the N found neighboring points. Further, the spatial-relationship-based inter-frame nearest neighbor search algorithm may be combined with an inter-frame fast search algorithm. When a quantity of neighboring points found by the inter-frame attribute nearest neighbor search based on the spatial relationship is less than N, the fast search algorithm is used to perform nearest neighbor search in the reference frame, to find N inter-frame neighboring points. That is, the fast search algorithm may be used to modify the spatial-relationship-based inter-frame nearest neighbor search algorithm, thereby further improving attribute encoding efficiency of the point cloud.

In some embodiments, the fast search algorithm may include: determining the Morton code of the current point based on the geometric position information of the current point; searching, according to the Morton code of the current point, the reference frame for the first reference point whose Morton code is greater than the Morton code of the current point; determining a search range of points in the reference frame by using the reference point as a central point; and performing nearest neighbor search according to the search range of the points, to determine N neighboring points of the current point. Reference may be made to FIG. 31A.

In some embodiments, the fast search algorithm may be a block-based fast search algorithm. Specifically, the Morton code of the current point is determined based on the geometric position information of the current point; the reference frame is searched, according to the Morton code of the current point, for the first reference point whose Morton code is greater than the Morton code of the current point; the search range of the points in the reference frame is determined by using the reference point as the central point; a search range of reference blocks in the reference frame is determined based on the search range of the points; and nearest neighbor search is performed according to the search range of the reference blocks, to determine the N neighboring points of the current point. Reference may be made to FIG. 31B.

In some embodiments, the fast search algorithm may be a block-based fast search algorithm. Specifically, the block-based fast search algorithm may include: determining the Morton code of the current point based on the geometric position information of the current point; searching, according to the Morton code of the current point, for the first reference point whose Morton code is greater than the Morton code of the current point; determining the search range of the points in the reference frame by using the reference point as the central point; determining the search range of the reference blocks in the reference frame based on the search range of the points; and performing nearest neighbor search according to the search range of the reference blocks, to determine the N neighboring points of the current point.

Step 105: Perform attribute prediction on the current point according to the N neighboring points, to determine a reconstructed attribute value of the current point.

Exemplarily, a weighted prediction mode of the current point is determined, and the reconstructed attribute value of the current point is determined based on the weighted prediction mode of the current point and reconstructed attribute values of the N neighboring points.

In some embodiments, the method further includes: decoding the bitstream to determine third syntax element identification information; and in a case that the third syntax element identification information indicates that an inter-frame nearest neighbor search algorithm is used to perform attribute prediction on the to-be-decoded unit, decoding the bitstream to determine the first syntax element identification information.

It should be noted that the third syntax element identification information is used to indicate whether to use the inter-frame nearest neighbor search algorithm to perform attribute prediction on the to-be-decoded unit. The inter-frame nearest neighbor search algorithm includes a spatial-relationship-based inter-frame nearest neighbor search algorithm. Only when it is determined that the inter-frame nearest neighbor search algorithm is allowed to be used to perform attribute prediction on the to-be-decoded unit, the decoding method provided in step 101 to step 105 according to embodiments of this application is further executed.

In some embodiments, the third syntax element identification information includes at least one of the following: a sequence-level syntax element, a frame-level syntax element, or a slice-level syntax element. Exemplarily, the bitstream is decoded to determine an attribute data unit header syntax; and the third syntax element identification information is determined from the attribute data unit header syntax.

In embodiments of this application, descriptions of attribute syntax elements in header information (Attribute data unit header syntax) are shown in Table 2.

TABLE 2

| | Descriptor | Semantics |
|---|---|---|
| attribute_data_unit_header( ) { | | |
| adu_attr_parameter_set_id | u(4) | 7.4.4.2 |
| adu_reserved_zero_3bits | u(3) | 7.4.4.2 |
| adu_sps_attr_idx | ue(v) | 7.4.4.2 |
| adu_slice_id | ue(v) | 7.4.4.2 |
| if( lod_dist_log2_offset_present ) | | |
| lod_dist_log2_offset | se(v) | 10.6.2 |
| if( last_comp_pred_enabled && AttrDim | | |
| for(dpth = 0; dpth | | |
| dpth++ ) | | |
| last_comp_pred_coeff_diff dpth] | se(v) | 10.6.10.1 |
| if( inter_comp_pred_enabled ) | | |
| for(dpth = 0; dpth | | |
| dpth++ ) | | |
| <AttrDim; ++) | | |
| inter_comp_pred_coeff_diff dpth | se(v) | 10.6.10.1 |
| if( attr_qp_offsets_present ) | | |
| for(qc = 0; qc AttrDim); qc++) | | |
| attr_qp_offset qc] | se(v) | 10.7.1 |
| attr_qp_layers_present | u(1) | 10.7.1 |
| if( attr_qp_layers_present ) { | | |
| attr_qp_layer_cnt_minus1 | ue(v) | 10.7.1 |
| for(dpth = 0; dpth :S | | |
| attr_qp_layer_cnt_minus1; dpth++) | | |
| for(qc = 0; qc < Min(2, AttrDim); qc++) | | |
| attr_qp_layer_offset[dpth ][qc ] | se(v) | 10.7.1 |
| } | | |
| attr_qp_region_cnt | ue(v) | 10.7.1 |
| if(attr_qp_region_cnt) | | |
| attr_qp_region_bits_minus1 | ue(v) | 10.7.1 |
| for(= O; < attr_qp_region_cnt; ++) { | | |
| if(---.attr_coord_conv_enabled) { | | |
| for(= O; < 3; ++) | | |
| attr_qp_region_origin_xyz[ ][ ] | u(v) | 10.7.1 |
| for( = 0; < 3; ++) | | |
| attr_qp_region_size_minus1_xyz[ | u(v) | 10.7.1 |
| ][ ] | | |
| } else { | | |
| for( = 0; < 3; ++) | | |
| attr_qp_region_origin_rpi[ ][ ] | u(v) | 10.7.1 |
| for(= O; < 3; ++) | | |
| attr_qp_region_size_minus1_rpi[ ][ ] | u(v) | 10.7.1 |
| } | | |
| for(ps = 0; ps < Min(2, AttrDim); ps++) | | |
| attr_qp_region_offset[ ][ps] | se(v) | 10.7.1 |
| } | | |
| disableAttrInterPred//Whether to disable | u(1) | |
| inter-frame attribute nearest neighbor search for | | |
| attribute prediction? | | |
| if(!disableAttrInterPred) | | |
| lod_dist_log2_offset_{—} | u(1) | |
| inter_present//Whether to | | |
| encode or decode an initial block size | | |
| if | | |
| inter_lod_dist_log2 | ue(v) | |
| } | | |
| byte_alignment( ) | | |
| } | | |

In embodiments of this application, a spatial-relationship-based inter-frame nearest neighbor search algorithm is first introduced in APS, to perform attribute prediction, and a higher-level syntax element that enables the spatial-relationship-based inter-frame nearest neighbor search algorithm to perform attribute prediction needs to be transferred in the APS. When attribute encoding is performed on each slice, a rate distortion cost of each slice in each encoding mode is calculated at an encoding end, whether to use the inter-frame nearest neighbor search algorithm based on the spatial relationship to perform attribute prediction is adaptively selected for each slice, and is transmitted to a decoding end by using lod_dist_log 2_offset_inter present (corresponding to first syntax element identification information). When the spatial-relationship-based inter-frame nearest neighbor search algorithm is used to perform attribute prediction, an optimal block size corresponding to an initial LOD layer of the slice is determined and then transferred to the decoding end by using inter_lod_dist_log 2. The decoding end determines the block size corresponding to the initial LOD layer based on lod_dist_log 2_offset_inter present and inter_lod_dist_log 2, performs attribute prediction by using the spatial-relationship-based inter-frame nearest neighbor search algorithm, and reconstructs an attribute of the point cloud, thereby further improving attribute encoding efficiency of the point cloud.

It may be understood that, in embodiments of this application, a video frame may be understood as an image. For example, the current frame may be understood as a current image, and the reference frame may be understood as a reference image.

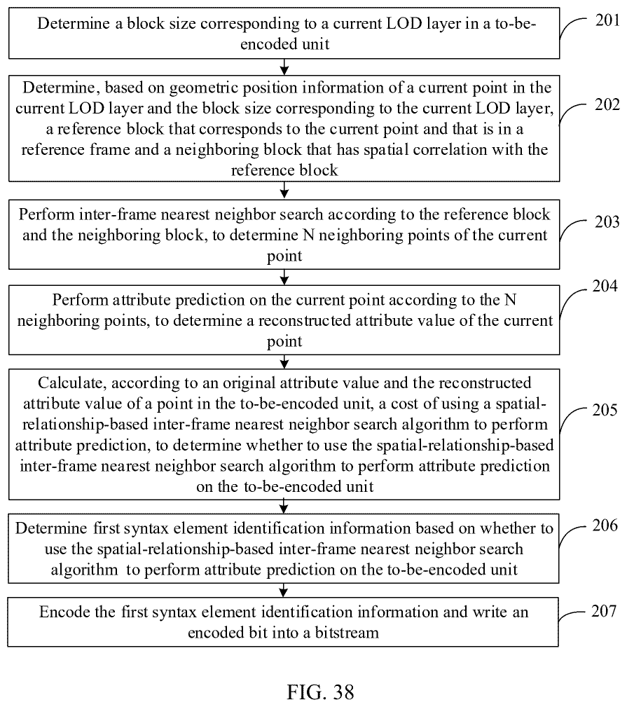

In another embodiment of this application, referring to FIG. 38, FIG. 38 is a schematic flowchart of an encoding method according to this embodiment of this application. As shown in FIG. 38, the method may include the following steps.

Step 201: Determine a block size corresponding to a current LOD layer in a to-be-encoded unit.

In some embodiments, the determining the block size corresponding to the current LOD layer in the to-be-encoded unit may include: determining a block size corresponding to an initial LOD layer in the to-be-encoded unit; and determining, based on the block size corresponding to the initial LOD layer, the block size corresponding to the current LOD layer in the to-be-encoded unit.

In some embodiments, the determining the block size corresponding to the initial LOD layer in the to-be-encoded unit may include: determining a sample point set of the to-be-encoded unit; performing inter-frame nearest neighbor search according to geometric position information of a first sample point in the sample point set, to determine the nearest neighboring point of the first sample point; determining a distance between the first sample point and the nearest neighboring point based on the geometric position information of the first sample point and geometric position information of the nearest neighboring point of the first sample point; sorting sample points in the sample point set according to distances of the sample points, to determine a distance of the W^{th} sample point; and determining, based on the distance of the W^{th} sample point, the block size corresponding to the initial LOD layer of the to-be-encoded unit. Exemplarily, the distance may be a Manhattan distance D from a sample point to the nearest neighboring point, and a side length of the block size is calculated as follows: width=/3.

In some embodiments, the determining, based on the block size corresponding to the initial LOD layer, the block size corresponding to the current LOD layer in the to-be-encoded unit includes: when the current LOD layer is not the initial LOD layer, determining a block size corresponding to the (i−1)^{th} LOD layer based on a block size corresponding to the i^{th} LOD layer and a preset scaling parameter, where the block size corresponding to the initial LOD layer is an initial parameter of the block size corresponding to the i^{th} LOD layer.

As shown in FIG. 21 and FIG. 23, according to a sequence of generating LODs, the initial LOD layer may be the last generated LOD layer, and points in the initial LOD layer are most densely distributed. From the last generated LOD layer to the first generated LOD layer, point density decreases. Therefore, after the block size corresponding to the initial LOD layer is determined, block sizes corresponding to other LOD layers are successively determined based on the block size corresponding to the initial LOD layer and the preset scaling parameter. Exemplarily, a scaling parameter between two neighboring layers may be set to 2.

It should be noted that, in embodiments of this application, a block size corresponding to each LOD layer may be further determined based on the foregoing method for determining the block size corresponding to the initial LOD layer. Details are not described herein again.

In some embodiments, the determining the block size corresponding to the current LOD layer in the to-be-encoded unit may include: determining the block size corresponding to the initial LOD layer in the to-be-encoded unit as a preset block size.

Step 202: Determine, based on geometric position information of a current point in the current LOD layer and the block size corresponding to the current LOD layer, a reference block that corresponds to the current point and that is in a reference frame and a neighboring block that has spatial correlation with the reference block.

In some embodiments, the spatial correlation includes at least one of the following: coplanar, co-edge, or co-vertex. FIG. 27A is a schematic diagram of a coplanar spatial relationship, FIG. 27B is a schematic diagram of coplanar and co-edge spatial relationships, and FIG. 27C is a schematic diagram of coplanar, co-edge, and co-vertex spatial relationships.

In some embodiments, the determining, based on the geometric position information of the current point in the current LOD layer and the block size corresponding to the current LOD layer, the reference block that corresponds to the current point and that is in the reference frame and the neighboring block that has spatial correlation with the reference block includes: determining, based on the geometric position information of the current point in the current LOD layer and the block size corresponding to the current LOD layer, geometric position information of the reference block that corresponds to the current point and that is in the reference frame; and determining, based on the geometric position information of the reference block and the block size corresponding to the current LOD layer, the neighboring block that has spatial correlation with the reference block.

Exemplarily, geometric position information of a reference point that corresponds to the current point and that is in the reference frame is determined based on the geometric position information of the current point; the geometric position information of the reference block in which the reference point is located is determined based on the geometric position information of the reference point and the block size corresponding to the current LOD layer; and position information of the neighboring block that has spatial correlation with the reference block is determined based on the geometric position information of the reference block and the block size corresponding to the current LOD layer. More specifically, a Morton code of the current point is determined based on the geometric position information of the current point; the reference frame is searched, according to the Morton code of the current point, for the first reference point whose Morton code is greater than the Morton code of the current point; and geometric position information of the reference point is determined based on the Morton code of the reference point.

FIG. 37 is a schematic spatial relationship diagram of inter-frame nearest neighbor search based on a spatial relationship. As shown in FIG. 37, when inter-frame nearest neighbor search is performed on a current point, a reference block that corresponds to the current point and that is in a reference frame is a cube central block. First, the reference frame is searched for a neighboring block that shares a face, an edge, or a vertex with the reference block corresponding to the current point, and then nearest neighbor search is performed by using points in the found nearest neighboring block, to determine N inter-frame neighboring points for attribute prediction, thereby improving attribute encoding and decoding efficiency of a point cloud.

Step 203: Perform inter-frame nearest neighbor search according to the reference block and the neighboring block, to determine N neighboring points of the current point.

In some embodiments, the method further includes: determining that a quantity of neighboring points of the current point obtained by performing the inter-frame nearest neighbor search according to the reference block and the neighboring block is less than N; and performing nearest neighbor search in the reference frame by using a fast search algorithm, to determine the N neighboring points of the current point.

It should be noted that, in embodiments of this application, the reference frame is searched, by using a spatial relationship of the current point, for a neighboring block that shares a face, an edge, or a vertex with a parent block corresponding to the current point, nearest neighbor search is performed on the found neighboring block, and inter prediction is performed on an attribute of the current point according to the N found neighboring points. Further, the spatial-relationship-based inter-frame nearest neighbor search algorithm may be combined with an inter-frame fast search algorithm. When a quantity of neighboring points found by the inter-frame attribute nearest neighbor search based on the spatial relationship is less than N, the fast search algorithm is used to perform nearest neighbor search in the reference frame, to find N inter-frame neighboring points. That is, the fast search algorithm may be used to modify the spatial-relationship-based inter-frame nearest neighbor search algorithm, thereby further improving attribute encoding efficiency of the point cloud.

In some embodiments, the fast search algorithm may include: determining the Morton code of the current point based on the geometric position information of the current point; searching, according to the Morton code of the current point, the reference frame for the first reference point whose Morton code is greater than the Morton code of the current point; determining a search range of points in the reference frame by using the reference point as a central point; and performing nearest neighbor search according to the search range of the points, to determine N neighboring points of the current point. Reference may be made to FIG. 31A.

In some embodiments, the fast search algorithm may be a block-based fast search algorithm. Specifically, the Morton code of the current point is determined based on the geometric position information of the current point; the reference frame is searched, according to the Morton code of the current point, for the first reference point whose Morton code is greater than the Morton code of the current point; the search range of the points in the reference frame is determined by using the reference point as the central point; a search range of reference blocks in the reference frame is determined based on the search range of the points; and nearest neighbor search is performed according to the search range of the reference blocks, to determine the N neighboring points of the current point. Reference may be made to FIG. 31B.

In some embodiments, the fast search algorithm may be a block-based fast search algorithm. Specifically, the block-based fast search algorithm may include: determining the Morton code of the current point based on the geometric position information of the current point; searching, according to the Morton code of the current point, for the first reference point whose Morton code is greater than the Morton code of the current point; determining the search range of the points in the reference frame by using the reference point as the central point; determining the search range of the reference blocks in the reference frame based on the search range of the points; and performing nearest neighbor search according to the search range of the reference blocks, to determine the N neighboring points of the current point.

Step 204: Perform attribute prediction on the current point according to the N neighboring points, to determine a reconstructed attribute value of the current point.

Exemplarily, a weighted prediction mode of the current point is determined, and the reconstructed attribute value of the current point is determined based on the weighted prediction mode of the current point and reconstructed attribute values of the N neighboring points.

Step 205: Calculate, according to an original attribute value and the reconstructed attribute value of a point in the to-be-encoded unit, a cost of using a spatial-relationship-based inter-frame nearest neighbor search algorithm to perform attribute prediction, to determine whether to use the spatial-relationship-based inter-frame nearest neighbor search algorithm to perform attribute prediction on the to-be-encoded unit.

It should be noted that encoding decision is performed through the cost calculation, and an optimal attribute prediction mode is selected from the attribute prediction mode of using the spatial-relationship-based inter-frame nearest neighbor search algorithm to perform attribute prediction and attribute prediction modes, as an attribute prediction mode of the current to-be-encoded unit.

In embodiments of this application, a cost function for performing cost calculation may be a sum of absolute differences (Sum of Absolute Difference, SAD), a sum of absolute transformed differences (Sum of Absolute Transformed Difference, SATD), a mean squared error (Mean Square Error, MSE), a sum of squared differences (Sum of Squared Differences, SSD), a mean absolute deviation (Mean Absolute Deviation, MAD), a mean squared difference (Mean Square Differences, MSD), rate-distortion optimization (Rate-distortion optimization, RDO), a normalized correlation coefficient (Normalized Correlation Coefficient, NCC), a peak signal-to-noise ratio (Peak Signal to Noise Ratio, PSNR), or the like. This is not specifically limited herein.

Step 206: Determine first syntax element identification information based on whether to use the spatial-relationship-based inter-frame nearest neighbor search algorithm to perform attribute prediction on the to-be-encoded unit.

Step 207: Encode the first syntax element identification information and write an encoded bit into a bitstream.

It should be noted that, in embodiments of this application, the encoding method is applied to a point cloud encoder (which may be referred to as an “encoder” for short). The encoding method may be specifically a point cloud attribute encoding method. More specifically, a spatial-relationship-based inter-frame nearest neighbor search algorithm is used to perform attribute prediction on a point cloud attribute, in which N neighboring points are determined, and the attribute is predicted by using reconstructed attribute values of the N neighboring points.

It should be further noted that, in embodiments of this application, a spatial-relationship-based inter-frame nearest neighbor search algorithm is introduced to perform attribute prediction, and correlation between geometric spatial distribution of point clouds is considered, thereby improving attribute encoding efficiency of a point cloud. Specifically, a switch may be introduced into a higher-level syntax element, to control whether to use a spatial-relationship-based inter-frame nearest neighbor search algorithm to perform attribute prediction on a to-be-encoded unit. That is, the first syntax element identification information is used to indicate whether to use a spatial-relationship-based inter-frame nearest neighbor search algorithm to perform attribute prediction on a to-be-encoded unit.

In some embodiments, the method further includes: when the first syntax element identification information is a first value, determining that the spatial-relationship-based inter-frame nearest neighbor search algorithm is used to perform attribute prediction on the to-be-encoded unit; or when the first syntax element identification information is a second value, determining that the spatial-relationship-based inter-frame nearest neighbor search algorithm is not used to perform attribute prediction on the to-be-encoded unit.

It should be noted that in embodiments of this application, the first syntax identification information may be represented by lod_dist_log 2_offset_inter_present. The first value may be in a parameter form, or may be in a numeric form. For example, the first value may be set to 1, and the second value may be set to 0.

In some embodiments, the to-be-encoded unit may be a to-be-encoded slice. Exemplarily, a current frame may be divided into a plurality of pieces, for example, Slice_0, Slice_1, Slice_2, and Slice_3. For each slice, the first syntax element identification information may be used to indicate whether to use the spatial-relationship-based inter-frame nearest neighbor search algorithm to perform attribute prediction.

In some embodiments, the first syntax element identification information includes at least one of the following: a sequence-level syntax element, a frame-level syntax element, or a slice-level syntax element. It should be noted that, a sequence-level syntax element is used to indicate whether to use the spatial-relationship-based inter-frame nearest neighbor search algorithm to perform attribute prediction on a current sequence; a frame-level syntax element is used to indicate whether to use the spatial-relationship-based inter-frame nearest neighbor search algorithm to perform attribute prediction on a current frame; and a slice-level syntax element is used to indicate whether to use the spatial-relationship-based inter-frame nearest neighbor search algorithm to perform attribute prediction on a current slice.

Exemplarily, the first syntax element identification information includes a sequence-level syntax element, a frame-level syntax element, and a slice-level syntax element. Exemplarily, the first syntax element identification information includes a sequence-level syntax element. Exemplarily, the first syntax element identification information includes a frame-level syntax element.

In some embodiments, the encoding the first syntax element identification information and writing the encoded bit into the bitstream includes: writing the first syntax element identification information into an attribute data unit header syntax; and encoding the attribute data unit header syntax and writing the encoded bit into the bitstream.

In some embodiments, the to-be-encoded unit may be another image unit, for example, a coding tree unit (Coding Tree Unit, CTU) or a coding unit (Coding Unit, CU).

In some embodiments, the method further includes: in a case that the first syntax element identification information indicates that the spatial-relationship-based inter-frame nearest neighbor search algorithm is used to perform attribute prediction on the to-be-encoded unit, determining second syntax element identification information based on the block size corresponding to the initial LOD layer; and encoding the second syntax element identification information and writing an encoded bit into the bitstream.

It should be noted that an encoding end indicates the block size corresponding to the initial LOD layer by using the second syntax element identification information, and a decoding end indicates the block size corresponding to the initial LOD layer by using the second syntax element identification information, and then derives a block size corresponding to another layer according to the block size corresponding to the initial LOD layer.

In some embodiments, a reference value of the block size corresponding to the initial LOD layer is determined based on the block size corresponding to the initial LOD layer; and the second syntax element identification information is determined based on the reference value of the block size.

In some embodiments, the method further includes: in a case that the first syntax element identification information indicates that the spatial-relationship-based inter-frame nearest neighbor search algorithm is used to perform attribute prediction on the to-be-encoded unit, determining second syntax element identification information based on a block size corresponding to a current LOD layer; and encoding the second syntax element identification information and writing an encoded bit into the bitstream. That is, the second syntax element identification information is set for a respective LOD layer, and is used to indicate a block size corresponding to the respective LOD layer.

In some embodiments, the encoding the second syntax element identification information and writing the encoded bit into the bitstream includes: writing the second syntax element identification information into an attribute data unit header syntax; and encoding the attribute data unit header syntax and writing the encoded bit into the bitstream.

Exemplarily, in embodiments of this application, an initial block size corresponding to the current to-be-encoded unit may be obtained by using the following algorithm:
1) Random sampling is performed on points in the current to-be-encoded unit. Assuming that a sampling interval is K, corresponding M sampling points are obtained.
2) Then, corresponding prediction points are obtained from the reference frame according to spatial positions of the sampling points. A specific neighboring node search algorithm is as follows.
a) It is assumed that a Morton code of the current to-be-encoded node is M. The first reference node whose Morton code is greater than the Morton code of the current to-be-encoded node is obtained from the reference frame, and it is assumed that a Morton code index of the reference node is j.
b) Then, nearest neighbor search is performed within a range of [j-searchRange, j+searchRange], to obtain the nearest neighbor of the current to-be-encoded node, and a distance D between the nearest neighbor and the current to-be-encoded node is calculated.
3) Based on such an algorithm, M sampling distances are sorted, and finally the W^{th} distance is selected as a distance for initially dividing blocks. Therefore, the initial block size is as follows:

width=
4) Integerization processing is performed. Therefore, finally a corresponding shift amount of the initial block size is calculated as follows:

shift=log ₂(width)
5) Finally, the shift is transferred to the decoding end. The decoding end restores the the initial block size according to the parameter, and reconstructs an attribute by using the the initial block size.

In some embodiments, the method further includes: determining third syntax element identification information, where the third syntax element identification information is used to indicate whether to use an inter-frame nearest neighbor search algorithm to perform attribute prediction on the to-be-encoded unit; in a case that the third syntax element identification information indicates that the inter-frame nearest neighbor search algorithm is used to perform attribute prediction on the to-be-encoded unit, determining the first syntax element identification information; and encoding the third syntax element identification information and writing an encoded bit into the bitstream.

It should be noted that the third syntax element identification information is used to indicate whether to use the inter-frame nearest neighbor search algorithm to perform attribute prediction on the to-be-encoded unit. The inter-frame nearest neighbor search algorithm includes the inter-frame nearest neighbor search algorithm based on the spatial relationship. Only when it is determined that the inter-frame nearest neighbor search algorithm is allowed to be used to perform attribute prediction on the to-be-decoded unit, the encoding method provided in step 201 to step 207 according to embodiments of this application is further executed.

In some embodiments, the third syntax element identification information includes at least one of the following: a sequence-level syntax element, a frame-level syntax element, or a slice-level syntax element. Exemplarily, the third syntax element identification information is written into an attribute data unit header syntax, and the attribute data unit header syntax is encoded.

In embodiments of this application, descriptions of attribute syntax elements in header information (Attribute data unit header syntax) are shown in Table 2.

In embodiments of this application, a specific implementation is described in detail with reference to the foregoing embodiments. It can be learned from the foregoing embodiments that, a point cloud attribute hierarchical prediction algorithm based on a spatial domain structure is used. First, LOD spatial division is performed on point cloud data, and then in attribute prediction on points in each layer, block division is performed on point cloud data of a reference frame. Then, neighbor search is performed by using a spatial relationship of blocks (including a neighboring block that shares a face, an edge, or a vertex with a reference block), and weighted prediction is performed on an attribute of a current point by using N found neighboring points. In this solution, encoding efficiency of attribute information can be further improved by further considering spatial correlation between point cloud attributes. Exemplarily, Table 3 and Table 4 show test results of attribute encoding efficiency.

TABLE 3

| [symbol] | lossless geometry, lossy | | | |
|---|---|---|---|---|
| [symbol] | attributes [all intra] | | | |
| [symbol] | End-to-End BD-AttrRate [%] | | | |
| [symbol] | | Chroma | Chroma | |
| [symbol] | Luma | Cb | Cr | Reflectance |
| Solid average | #VALUE! | #VALUE! | #VALUE! | |
| Dense average | #VALUE! | #VALUE! | #VALUE! | |
| Sparse average | #VALUE! | #VALUE! | #VALUE! | |
| Scant average | #VALUE! | #VALUE! | #VALUE! | |
| Am-fused average | #VALUE! | #VALUE! | #VALUE! | #VALUE! |
| Am-frame spinning | | | | −8.1% |
| average | | | | |
| Am-frame non- | #VALUE! | #VALUE! | | 0.0% |
| spinning average | | | | |
| Overall average | | | #VALUE! | #VALUE! |

| | |
|---|---|
| [symbol] | #NUM! |
| Avg. Dec Time [%] | #NUM! |

[symbol]

indicates data missing or illegible when filed

TABLE 4

| | lossy geometry, lossy attributes [all intra] | | | | | |
|---|---|---|---|---|---|---|
| | End-to-End BD-AttrRate [%] | | | | Geom. BD-TotGeomRate [%] | |
| C2_ai | Luma | Chroma Cb | Chroma Cr | Reflectance | D1 | D2 |
| Solid average | #VALUE! | #VALUE! | #VALUE! | | #VALUE! | #VALUE! |
| Dense average | #VALUE! | #VALUE! | #VALUE! | | #VALUE! | #VALUE! |
| Sparse average | #VALUE! | #VALUE! | #VALUE! | | #VALUE! | #VALUE! |
| Scant average | #VALUE! | #VALUE! | #VALUE! | | #VALUE! | #VALUE! |
| Am-fused average | #VALUE! | #VALUE! | #VALUE! | #VALUE! | #VALUE! | #VALUE! |
| Am-frame spinning average | | | | −10.1% | 0.0% | 0.0% |
| Overall average | #VALUE! | #VALUE! | #VALUE! | #VALUE! | #VALUE! | #VALUE! |

In still another embodiment of this application, a bitstream is further provided, where the bitstream is generated by performing bit encoding according to to-be-encoded information. The to-be-encoded information includes at least one of the following: first syntax element identification information, second syntax element identification information, or third syntax element identification information.

The first syntax identifier information is used to indicate whether to use a spatial-relationship-based inter-frame nearest neighbor search algorithm to perform attribute prediction on a to-be-decoded unit, the second syntax element identification information is used to indicate a block size corresponding to a current LOD layer, and the third syntax element identification information is used to indicate whether to use an inter-frame nearest neighbor search algorithm to perform attribute prediction on the to-be-decoded unit.

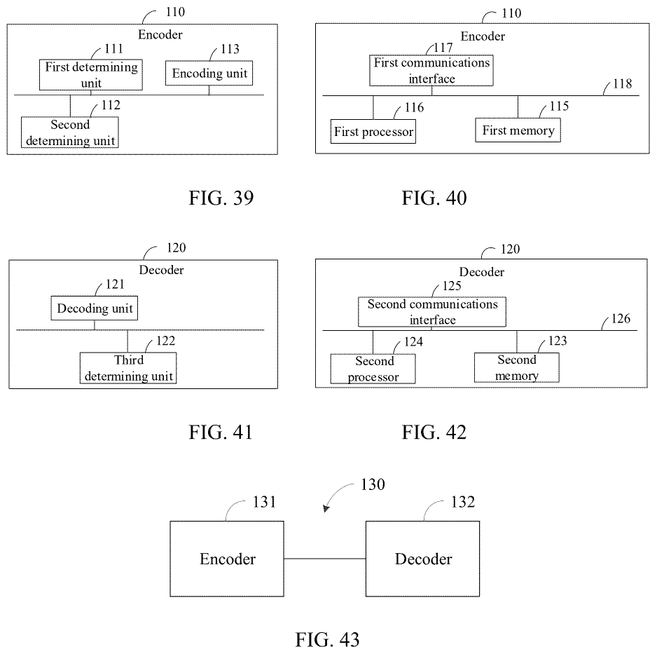

In another embodiment of this application, based on a same invention concept as the foregoing embodiments, FIG. 39 is a schematic structural diagram of an encoder according to this embodiment of this application. As shown in FIG. 39, the encoder 110 may include a first determining unit 111, a second determining unit 112, and an encoding unit 113.

The first determining unit 111 is configured to: determine a block size corresponding to a current LOD layer in a to-be-encoded unit; determine, based on geometric position information of a current point in the current LOD layer and the block size corresponding to the current LOD layer, a reference block that corresponds to the current point and that is in a reference frame and a neighboring block that has spatial correlation with the reference block; perform inter-frame nearest neighbor search according to the reference block and the neighboring block, to determine N neighboring points of the current point; and perform attribute prediction on the current point according to the N neighboring points, to determine a reconstructed attribute value of the current point.

The second determining unit 112 is configured to: calculate, according to an original attribute value and the reconstructed attribute value of a point in the to-be-encoded unit, a cost of using a spatial-relationship-based inter-frame nearest neighbor search algorithm to perform attribute prediction, to determine whether to use the spatial-relationship-based inter-frame nearest neighbor search algorithm to perform attribute prediction on the to-be-encoded unit.

The second determining unit 112 is further configured to determine first syntax element identification information based on whether to use the spatial-relationship-based inter-frame nearest neighbor search algorithm to perform attribute prediction on the to-be-encoded unit.

The encoding unit 113 is configured to encode the first syntax element identification information and write an encoded bit into a bitstream.

It may be understood that in embodiments of this application, the term “unit” may be a partial circuit, a partial processor, a partial program or software, or the like. Certainly, the term “unit” may be a module or may be in a non-modular form. In addition, components in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of embodiments essentially, or the part contributing to the conventional technology, or all or some of the technical solutions may be implemented in a form of a software product. The computer software product is stored in a storage medium and includes several instructions for instructing a computer device (which may be a personal computer, a server, or a network device) or a processor to execute all or some of the steps of the methods described in the embodiments. The foregoing storage medium includes various media that may store a program code, such as a USB flash drive, a removable hard disk, a read-only memory (Read Only Memory, ROM), a random access memory (Random Access Memory, RAM), a magnetic disk, or an optical disc.

Therefore, an embodiment of this application provides a computer-readable storage medium, applied to an encoder 110. The computer-readable storage medium stores a computer program, and the computer program is executed by a first processor to implement the method according to any one of the foregoing embodiments.

Based on the composition of the encoder 110 and the computer-readable storage medium, FIG. 40 is a schematic diagram of a structure of specific hardware of the encoder 110 according to an embodiment of this application. As shown in FIG. 40, the encoder 110 may include a first memory 115, a first processor 116, a first communications interface 117, and a first bus system 118. The first memory 115, the first processor 116, and the first communications interface 117 are coupled by using the first bus system 118. It may be understood that the first bus system 118 is configured to implement connection and communication between these components. The first bus system 118 may further include a power bus, a control bus, a status signal bus, and the like in addition to a data bus. However, for clarity of description, various buses are all marked as the first bus system 118 in FIG. 20.

The first communications interface 117 is configured to receive and transmit signals in a process of transmitting and receiving information with other external network elements.

The first memory 115 is configured to: store a computer program runnable on the first processor;
determine a block size corresponding to a current LOD layer in a to-be-encoded unit;
determine, based on geometric position information of a current point in the current LOD layer and the block size corresponding to the current LOD layer, a reference block that corresponds to the current point and that is in a reference frame and a neighboring block that has spatial correlation with the reference block;
perform inter-frame nearest neighbor search according to the reference block and the neighboring block, to determine N neighboring points of the current point;
perform attribute prediction on the current point according to the N neighboring points, to determine a reconstructed attribute value of the current point;
calculate, according to an original attribute value and the reconstructed attribute value of a point in the to-be-encoded unit, a cost of using a spatial-relationship-based inter-frame nearest neighbor search algorithm to perform attribute prediction, to determine whether to use the spatial-relationship-based inter-frame nearest neighbor search algorithm to perform attribute prediction on the to-be-encoded unit;
determine first syntax element identification information based on whether to use the spatial-relationship-based inter-frame nearest neighbor search algorithm to perform attribute prediction on the to-be-encoded unit; and
encode the first syntax element identification information and write an encoded bit into a bitstream.

It may be understood that, in embodiments of this application, the first memory 115 may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. By way of example rather than limitative description, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DRRAM). The first memory 115 in the systems and the methods described in this application includes but is not limited to these memories and any memory of another appropriate type.

However, the first processor 116 may be an integrated circuit chip having a signal processing capability. In an implementation process, steps in the foregoing method can be implemented by using a hardware integrated logical circuit in the first processor 116, or by using instructions in a form of software. The foregoing first processor 116 may be a general-purpose processor, a digital signal processor (Digital Signal Processor, DSP), an application-specific integrated circuit (Application Specific Integrated Circuit, ASIC), a field-programmable gate array (Field Programmable Gate Array, FPGA) or another programmable logic device, a discrete gate or transistor logic device, or a discrete hardware component. The processor can implement or execute the methods, steps and logical block diagrams disclosed in embodiments of this application. The general-purpose processor may be a microprocessor, or the processor may be any conventional processor or the like. The steps of the methods disclosed with reference to embodiments of this application may be directly executed by a hardware decoding processor, or executed by a combination of hardware and software modules in the decoding processor. The software module may be located in a mature storage medium in the art, for example, a random access memory, a flash memory, a read-only memory, a programmable read-only memory, an erasable programmable memory, or a register. The storage medium is located in the first memory 115, and the first processor 116 reads information in the first memory 115 and completes the steps of the foregoing methods in combination with hardware of the first processor.

It may be understood that these embodiments described in this application may be implemented by hardware, software, firmware, middleware, microcode, or a combination thereof. For hardware implementation, the processing unit may be implemented in one or more application-specific integrated circuits (Application Specific Integrated Circuits, ASIC), digital signal processors (Digital Signal Processing, DSP), digital signal processing devices (DSP Device, DSPD), programmable logic devices (Programmable Logic Device, PLD), field-programmable gate arrays (Field-Programmable Gate Array, FPGA), general-purpose processors, controllers, microcontrollers, microprocessors, and other electronic units configured to execute the functions described in this application, or a combination thereof. For software implementation, the technologies described in this application can be implemented by modules (such as processes and functions) that execute the functions described in this application. Software code may be stored in a memory and executed by a processor. The memory can be implemented in the processor or outside the processor.

Optionally, in another embodiment, the first processor 116 is further configured to execute the encoding method in any one of the foregoing embodiments when running the computer program.

An embodiment provides an encoder. In the encoder, first syntax element identification information is used to indicate whether to use a spatial-relationship-based inter-frame nearest neighbor search algorithm to perform attribute prediction on a to-be-encoded unit. If the spatial-relationship-based inter-frame nearest neighbor search algorithm is used to perform attribute prediction, inter-frame nearest neighbor search is performed on an attribute of a point cloud based on spatial correlation between point cloud attributes, and attribute prediction is performed by using N found neighboring points, so that correlation between point cloud attributes of neighboring frames can be further removed, thereby improving attribute encoding efficiency of the point cloud.

In still another embodiment of this application, based on a same invention concept as the foregoing embodiments, referring to FIG. 41, FIG. 41 is a schematic structural diagram of a decoder according to this embodiment of this application. As shown in FIG. 41, the decoder 120 may include a decoding unit 121 and a third determining unit 122.

The decoding unit 121 is configured to decode a bitstream to determine first syntax element identification information.

The third determining unit 122 is configured to: in a case that the first syntax element identification information indicates that a spatial-relationship-based inter-frame nearest neighbor search algorithm is used to perform attribute prediction on a to-be-decoded unit, determine a block size corresponding to a current LOD layer in the to-be-decoded unit.

The third determining unit 122 is further configured to: determine, based on geometric position information of a current point in the current LOD layer and the block size corresponding to the current LOD layer, a reference block that corresponds to the current point and that is in a reference frame and a neighboring block that has spatial correlation with the reference block; perform inter-frame nearest neighbor search according to the reference block and the neighboring block, to determine N neighboring points of the current point; and perform attribute prediction on the current point according to the N neighboring points, to determine a reconstructed attribute value of the current point.

It may be understood that in embodiments, the term “unit” may be a partial circuit, a partial processor, a partial program or software, or the like. Certainly, the term “unit” may be a module or may be in a non-modular form. In addition, components in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in the form of a software functional module and not sold or used as an independent product, the integrated unit may be stored in a computer-readable storage medium. Based on such an understanding, an embodiment provides a computer-readable storage medium, applied to the decoder 120. The computer-readable storage medium stores a computer program, and the computer program is executed by a second processor to implement the method according to any one of the foregoing embodiments.

Based on the composition of the decoder 120 and the computer-readable storage medium, referring to FIG. 42, FIG. 42 is a schematic diagram of a structure of specific hardware of the decoder 120 according to an embodiment of this application. As shown in FIG. 42, the decoder 120 may include a second memory 123, a second processor 124, a second communications interface 125, and a second bus system 126. The second memory 123, the second processor 124, and the second communications interface 125 are coupled by using the second bus system 126. It may be understood that the second bus system 126 is configured to implement connection and communication between these components. The second bus system 126 may further include a power bus, a control bus, a status signal bus, and the like, in addition to a data bus. However, for clarity of description, various buses are all marked as the second bus system 126 in FIG. 22.

The second communications interface 125 is configured to receive and transmit a signal in a process of transmitting and receiving information between the second communications interface and another external network element.

The second memory 123 is configured to store a computer program runnable on the second processor.

In some embodiments, the second processor 124 is configured to run the computer program to execute the following operations:
decoding a bitstream to determine first syntax element identification information;
in a case that the first syntax element identification information indicates that a spatial-relationship-based inter-frame nearest neighbor search algorithm is used to perform attribute prediction on a to-be-decoded unit, determining a block size corresponding to a current LOD layer in the to-be-decoded unit;
determining, based on geometric position information of a current point in the current LOD layer and the block size corresponding to the current LOD layer, a reference block that corresponds to the current point and that is in a reference frame and a neighboring block that has spatial correlation with the reference block;
performing inter-frame nearest neighbor search according to the reference block and the neighboring block, to determine N neighboring points of the current point; and
performing attribute prediction on the current point according to the N neighboring points, to determine a reconstructed attribute value of the current point.

Optionally, in another embodiment, the second processor 124 is further configured to run the computer program to execute the method according to any one of the foregoing embodiments.

It may be understood that hardware functions of the second memory 123 are similar to those of the first memory 115, and hardware functions of the second processor 124 are similar to those of the first processor 116, which is not detailed here.

An embodiment provides a decoder. In the decoder, first syntax element identification information is used to indicate whether to use a spatial-relationship-based inter-frame nearest neighbor search algorithm to perform attribute prediction on a to-be-decoded unit. If the spatial-relationship-based inter-frame nearest neighbor search algorithm is used to perform attribute prediction, inter-frame nearest neighbor search is performed on an attribute of a point cloud based on spatial correlation between point cloud attributes, and attribute prediction is performed by using N found neighboring points, so that correlation between point cloud attributes of neighboring frames can be further removed, thereby improving attribute decoding efficiency of the point cloud.

In another embodiment of this application, referring to FIG. 43, FIG. 43 is a schematic structural diagram of an encoding and decoding system according to this embodiment of this application. As shown in FIG. 43, the encoding and decoding system 130 may include an encoder 131 and a decoder 132.

In embodiments of this application, the encoder 131 may be the encoder according to any one of the foregoing embodiments, and the decoder 132 may be the decoder according to any one of the foregoing embodiments.

It should be noted that, in this application, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. In the absence of further restrictions, the element limited by the sentence “including a . . . ” does not exclude the existence of other identical elements in the process, method, item or device including this element.

The foregoing sequence numbers of embodiments of this application are merely described, and do not represent advantages or disadvantages of the embodiments.

The disclosed methods provided in the several method embodiments of this application may be randomly combined with each other in the case of no conflicts, to obtain new method embodiments.

The disclosed features provided in the several product embodiments of this application may be randomly combined with each other in the case of no conflicts, to obtain new product embodiments.

The disclosed features provided in the several method or device embodiments of this application may be randomly combined with each other in the case of no conflicts, to obtain new method embodiments or device embodiments.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

### Industrial Practicality

In embodiments of this application, first syntax element identification information is used to indicate whether to use a spatial-relationship-based inter-frame nearest neighbor search algorithm to perform attribute prediction on a to-be-encoded unit or a to-be-decoded unit. When the spatial-relationship-based inter-frame nearest neighbor search algorithm is used to perform attribute prediction, a block size corresponding to a current LOD layer in the to-be-decoded unit is further determined. A reference block corresponding to a current point in a reference frame and a neighboring block that has spatial correlation with the reference block are determined based on the block size corresponding to the current LOD layer, inter-frame nearest neighbor search is performed to determine N neighboring points of the current point, and attribute prediction is performed on the current point according to the N neighboring points, to determine a reconstructed attribute value. In this way, inter-frame nearest neighbor search is performed on an attribute of a point cloud based on spatial correlation between point cloud attributes, and attribute prediction is performed by using the N found neighboring points, so that correlation between point cloud attributes of neighboring frames can be further removed, thereby improving encoding and decoding efficiency of point cloud attributes.

What is claimed is:

1. A decoding method, applied to a decoder, wherein the method comprises:
decoding a bitstream to determine first syntax element identification information;
in a case that the first syntax element identification information indicates that a spatial-relationship-based inter-frame nearest neighbor search algorithm is used to perform attribute prediction on a to-be-decoded unit, determining a block size corresponding to a current LOD layer in the to-be-decoded unit;
determining, based on geometric position information of a current point in the current LOD layer and the block size corresponding to the current LOD layer, a reference block that corresponds to the current point and that is in a reference frame and a neighboring block that has spatial correlation with the reference block;
performing inter-frame nearest neighbor search according to the reference block and the neighboring block, to determine N neighboring points of the current point; and
performing attribute prediction on the current point according to the N neighboring points, to determine a reconstructed attribute value of the current point.

2. The method according to claim 1, wherein the method further comprises:
when the first syntax element identification information is a first value, determining that the spatial-relationship-based inter-frame nearest neighbor search algorithm is used to perform attribute prediction on the to-be-decoded unit; or
when the first syntax element identification information is a second value, determining that the spatial-relationship-based inter-frame nearest neighbor search algorithm is not used to perform attribute prediction on the to-be-decoded unit.

3. The method according to claim 1, wherein the to-be-decoded unit is a to-be-decoded slice.

4. The method according to claim 1, wherein the first syntax element identification information comprises at least one of following: a sequence-level syntax element, a frame-level syntax element, or a slice-level syntax element.

5. The method according to claim 4, wherein the decoding the bitstream to determine the first syntax element identification information comprises:
decoding the bitstream to determine an attribute data unit header syntax; and
determining the first syntax element identification information from the attribute data unit header syntax.

6. The method according to claim 1, wherein the determining the block size corresponding to the current LOD layer in the to-be-decoded unit comprises:
decoding the bitstream to determine second syntax element identification information; and
determining, based on the second syntax element identification information, the block size corresponding to the current LOD layer in the to-be-decoded unit.

7. The method according to claim 6, wherein the second syntax element identification information is used to indicate a block size corresponding to an initial LOD layer in the to-be-decoded unit; and
the determining, based on the second syntax element identification information, the block size corresponding to the current LOD layer in the to-be-decoded unit comprises:
determining, based on the second syntax element identification information, the block size corresponding to the initial LOD layer in the to-be-decoded unit; and
determining, based on the block size corresponding to the initial LOD layer, the block size corresponding to the current LOD layer in the to-be-decoded unit.

8. The method according to claim 7, wherein the determining, based on the second syntax element identification information, the block size corresponding to the initial LOD layer in the to-be-decoded unit comprises:
determining, based on the second syntax element identification information, a reference value of the block size corresponding to the initial LOD layer; and
determining, based on the reference value of the block size, the block size corresponding to the initial LOD layer.

9. The method according to claim 7, wherein the determining, based on the block size corresponding to the initial LOD layer, the block size corresponding to the current LOD layer in the to-be-decoded unit comprises:
when the current LOD layer is not the initial LOD layer, determining a block size corresponding to an (i−1)^{th} LOD layer based on a block size corresponding to an i^{th} LOD layer and a preset scaling parameter,
wherein the block size corresponding to the initial LOD layer is an initial parameter of the block size corresponding to the i^{th} LOD layer.

10. The method according to claim 6, wherein the decoding the bitstream to determine the second syntax element identification information comprises:
decoding the bitstream to determine an attribute data unit header syntax; and
determining the second syntax element identification information from the attribute data unit header syntax.

11. The method according to claim 1, wherein the determining, based on the geometric position information of the current point in the current LOD layer and the block size corresponding to the current LOD layer, the reference block that corresponds to the current point and that is in the reference frame and the neighboring block that has spatial correlation with the reference block comprises:
determining, based on the geometric position information of the current point, geometric position information of a reference point that corresponds to the current point and that is in the reference frame;
determining, based on the geometric position information of the reference point and the block size corresponding to the current LOD layer, geometric position information of the reference block in which the reference point is located; and
determining, based on the geometric position information of the reference block and the block size corresponding to the current LOD layer, position information of the neighboring block that has spatial correlation with the reference block.

12. The method according to claim 1, wherein the spatial correlation comprises at least one of following: coplanar, co-edge, or co-vertex.

13. The method according to claim 1, wherein the method further comprises:
determining that a quantity of neighboring points of the current point obtained by performing the inter-frame nearest neighbor search according to the reference block and the neighboring block is less than N; and
performing nearest neighbor search in the reference frame by using a fast search algorithm, to determine the N neighboring points of the current point.

14. The method according to claim 1, wherein the decoding the bitstream to determine the first syntax element identification information comprises:
decoding the bitstream to determine third syntax element identification information; and
in a case that the third syntax element identification information indicates that an inter-frame nearest neighbor search algorithm is used to perform attribute prediction on the to-be-decoded unit, decoding the bitstream to determine the first syntax element identification information.

15. An encoding method, applied to an encoder, wherein the method comprises:
determining a block size corresponding to a current LOD layer in a to-be-encoded unit;
determining, based on geometric position information of a current point in the current LOD layer and the block size corresponding to the current LOD layer, a reference block that corresponds to the current point and that is in a reference frame and a neighboring block that has spatial correlation with the reference block;
performing inter-frame nearest neighbor search according to the reference block and the neighboring block, to determine N neighboring points of the current point;
performing attribute prediction on the current point according to the N neighboring points, to determine a reconstructed attribute value of the current point;
calculating, according to an original attribute value and the reconstructed attribute value of a point in the to-be-encoded unit, a cost of using a spatial-relationship-based inter-frame nearest neighbor search algorithm to perform attribute prediction, to determine whether to use the spatial-relationship-based inter-frame nearest neighbor search algorithm to perform attribute prediction on the to-be-encoded unit;
determining first syntax element identification information based on whether to use the spatial-relationship-based inter-frame nearest neighbor search algorithm to perform attribute prediction on the to-be-encoded unit; and
encoding the first syntax element identification information and writing an encoded bit into a bitstream.

16. The method according to claim 15, wherein the method further comprises:
when the first syntax element identification information is a first value, determining that the spatial-relationship-based inter-frame nearest neighbor search algorithm is used to perform attribute prediction on the to-be-encoded unit; or
when the first syntax element identification information is a second value, determining that the spatial-relationship-based inter-frame nearest neighbor search algorithm is not used to perform attribute prediction on the to-be-encoded unit.

17. The method according to claim 15, wherein the to-be-encoded unit is a to-be-encoded slice.

18. The method according to claim 15, wherein the first syntax element identification information comprises at least one of following: a sequence-level syntax element, a frame-level syntax element, or a slice-level syntax element.

19. The method according to claim 18, wherein the encoding the first syntax element identification information and writing the encoded bit into the bitstream comprises:
writing the first syntax element identification information into an attribute data unit header syntax; and
encoding the attribute data unit header syntax and writing an encoded bit into the bitstream.

20. A non-transitory computer-readable storage medium, having a computer program and a bitstream stored thereon, wherein the computer program, when executed by a processor, enables the processor to perform following steps to generate the bitstream:
determining a block size corresponding to a current LOD layer in a to-be-encoded unit;
determining, based on geometric position information of a current point in the current LOD layer and the block size corresponding to the current LOD layer, a reference block that corresponds to the current point and that is in a reference frame and a neighboring block that has spatial correlation with the reference block;
performing inter-frame nearest neighbor search according to the reference block and the neighboring block, to determine N neighboring points of the current point;
performing attribute prediction on the current point according to the N neighboring points, to determine a reconstructed attribute value of the current point;
calculating, according to an original attribute value and the reconstructed attribute value of a point in the to-be-encoded unit, a cost of using a spatial-relationship-based inter-frame nearest neighbor search algorithm to perform attribute prediction, to determine whether to use the spatial-relationship-based inter-frame nearest neighbor search algorithm to perform attribute prediction on the to-be-encoded unit;
determining first syntax element identification information based on whether to use the spatial-relationship-based inter-frame nearest neighbor search algorithm to perform attribute prediction on the to-be-encoded unit; and
encoding the first syntax element identification information and writing an encoded bit into the bitstream.
